(19) United States
(12) Patent Application Publication
(10) Pub. No.: US 2024/0417632 A1
(43) Pub. Date: Dec. 19, 2024

(54) Multi-Stage Process and Device Utilizing Structured Catalyst Beds and Reactive Distillation for the Production of a Low Sulfur Heavy Marine Fuel Oil

(71) Applicant: Magëmã Technology LLC, Houston, TX (US)

(72) Inventors: Michael Joseph Moore, Houston, TX (US); Bertrand Ray Klussmann, Houston, TX (US); Carter James White, Houston, TX (US)

(73) Assignee: Magema Technology LLC, Houston, TX (US)

(21) Appl. No.: 18/814,500

(22) Filed: Aug. 24, 2024

Related U.S. Application Data
(62) Division of application No. 17/856,853, filed on Jul. 1, 2022, now Pat. No. 12,071,592.
Application No. 17/856,853 is a continuation-in-part of application No. 17/331,396, filed on May 26, 2021.
Application No. 17/331,396 is a continuation of application No. 16/719,485, filed on Dec. 18, 2019, now Pat. No. 11,021,662.
Application No. 16/719,485 is a continuation of application No. 16/103,896, filed on Aug. 14, 2018, now Pat. No. 10,836,966.
Application No. 16/103,896 is a continuation-in-part of application No. PCT/US2018/017863, filed on Feb. 12, 2018.
Application No. 16/103,896 is a continuation-in-part of application No. PCT/US2018/017855, filed on Feb. 12, 2018.
Application No. 17/856,853 is a continuation-in-part of application No. 16/103,887, filed on Aug. 14, 2018, now abandoned.
Application No. 16/103,887 is a continuation-in-part of application No. PCT/US2018/017863, filed on Feb. 12, 2018.
Application No. 16/103,887 is a continuation-in-part of application No. PCT/US2018/017855, filed on Feb. 12, 2018.
Application No. 17/856,853 is a continuation-in-part of application No. 17/199,148, filed on Mar. 11, 2021, now Pat. No. 11,441,084.
Application No. 17/199,148 is a continuation of application No. 16/681,063, filed on Nov. 12, 2019, now Pat. No. 10,954,456.
Application No. 17/856,853 is a continuation-in-part of application No. 16/103,884, filed on Aug. 14, 2018, now abandoned.
Application No. 16/103,884 is a continuation-in-part of application No. PCT/US2018/017863, filed on Feb. 12, 2018.
Application No. 16/103,884 is a continuation-in-part of application No. PCT/US2018/017855, filed on Feb. 12, 2018.
Application No. 16/681,063 is a continuation of application No. 16/103,895, filed on Aug. 14, 2018, now Pat. No. 10,563,133.
Application No. 16/103,895 is a continuation-in-part of application No. PCT/US2018/017863, filed on Feb. 12, 2018.
Application No. 16/103,895 is a continuation-in-part of application No. PCT/US2018/017855, filed on Feb. 12, 2018.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.
(60) Provisional application No. 62/589,479, filed on Nov. 21, 2017.
(60) Provisional application No. 62/458,002, filed on Feb. 12, 2017.

(51) Int. Cl. C10G 45/04; B01D 3/34; B01D 53/14; B01J 8/00; B01J 8/02; B01J 8/04; B01J 21/04; B01J 23/24; B01J 23/40; B01J 23/74; C10G 7/00; C10G 25/00; C10G 25/02; C10G 45/02; C10G 45/06; C10G 45/08; C10G 45/22; C10G 47/02; C10G 65/04; C10G 65/16; C10G 67/02; C10G 67/06; C10G 69/02; C10L 1/04; C10L 1/12; C10L 1/14; C10L 1/16

(52) U.S. Cl. CPC C10G 45/04; B01D 3/343; B01D 53/1481; B01J 8/008; B01J 8/0278; B01J 8/0292; B01J 8/0457; B01J 8/0492; B01J 21/04; B01J 23/24; B01J 23/40; B01J 23/74; C10G 7/00; C10G 25/003; C10G 25/02; C10G 45/02; C10G 45/06; C10G 45/08; C10G 45/22; C10G 47/02; C10G 65/04; C10G 65/16; C10G 67/02; C10G 67/06; C10G 69/02; C10L 1/04; C10L 1/12; C10L 1/14; C10L 1/1608; B01J 2208/00557; B01J 2208/02; B01J 2208/025; C10G 2300/1037; C10G 2300/1044; C10G 2300/1048; C10G 2300/1059; C10G 2300/107; C10G 2300/1077; C10G 2300/201; C10G 2300/202; C10G 2300/205; C10G 2300/206; C10G 2300/207; C10G 2300/208; C10G 2300/30; C10G 2300/302; C10G 2300/308; C10G 2300/4012; C10G 2300/4018; C10G 2300/4062; C10G 2300/70; C10G 2300/80; C10G 2400/04; C10G 2400/06; C10L 2200/0263; C10L 2200/0438; C10L 2270/02; C10L 2270/026

(57) ABSTRACT

A multi-stage process for the production of a Product Heavy Marine Fuel Oil compliant with ISO 8217:2017 as a Table 2 residual marine fuel from a high sulfur Feedstock Heavy Marine Fuel Oil compliant with ISO 8217:2017 as a Table 2 residual marine fuel except for the sulfur level, involving hydrotreating under reactive distillation conditions in a Reaction System composed of one or more reaction vessels. The reactive distillation conditions allow more than 75% by mass of the Process Mixture to exit the bottom of the reaction vessel as Product Heavy Marine Fuel Oil. The Product Heavy Marine Fuel Oil has a maximum sulfur content (ISO 14596 or ISO 8754) less than 0.5 mass %. A process plant for conducting the process for conducting the process is disclosed.

This application is a Divisional Application of co-pending application Ser. No. 17/856,853, filed 1 Jul. 2022, and: A) application Ser. No. 17/856,853 is a continuation-in-part of co-pending application Ser. No. 17/331,396, filed 26 May 2021; and 17/331396 claims priority as continuation of application Ser. No. 16/719,485, filed 18 Dec. 2019, now U.S. Pat. No. 11,021,662, granted 1 Jun. 2021; 16/719485 is a continuation of application Ser. No. 16/103,896, filed 14 Aug. 2018, now U.S. Pat. No. 10,836,966 granted 17 Nov. 2020, and 16/103896 is continuation-in-part of International Application No. PCT/US2018/017863, filed 12 Feb. 2018; PCT/US2018/017863 claims priority to U.S. Provisional Application No. 62/589,479 filed 21 Nov. 2017; PCT/US2018/017863 also claims priority to U.S. Provisional Application No. 62/458,002 filed 12 Feb. 2017; 16/103896 also claims priority as continuation-in-part of International Application No. PCT/US2018/017855, filed 12 Feb. 2018; PCT/US2018/017855 claims priority to U.S. Provisional Application No. 62/589,479 filed 21 Nov. 2017; PCT/US2018/017863 also claims priority to U.S. Provisional Application No. 62/458,002 filed 12 Feb. 2017; and, B) application Ser. No. 17/856,853 is a continuation-in-part of then co-pending application Ser. No. 16/103,887 filed 14 Aug. 2018; and 16/103,887 is a continuation-in-part of International Application No. PCT/US2018/017863, filed 12 Feb. 2018; PCT/US2018/017863 claims priority to U.S. Provisional Application No. 62/589,479 filed 21 Nov. 2017; PCT/US2018/017863 also claims priority to U.S. Provisional Application No. 62/458,002 filed 12 Feb. 2017; 16/103,887 is a continuation-in-part of International Application No. PCT/US2018/017855, filed 12 Feb. 2018; PCT/US2018/017855 claims priority to U.S. Provisional Application No. 62/589,479 filed 21 Nov. 2017; PCT/US2018/017863 also claims priority to U.S. Provisional Application No. 62/458,002 filed 12 Feb. 2017; and, C) application Ser. No. 17/856,853 is a continuation-in-part of then co-pending U.S. application Ser. No. 17/199,148, filed 11 Mar. 2021, now U.S. Pat. No. 11,441,084 granted 13 Sep. 2022; U.S. application Ser. No. 17/199,148 is a continuation of U.S. application Ser. No. 16/681,063, filed 12 Nov. 2019, now U.S. Pat. No. 10,954,456, granted 23 Mar. 2021; U.S. application Ser. No. 16/681,063 is a continuation/divisional application of U.S. application Ser. No. 16/103,895, filed 14 Aug. 2018, now U.S. Pat. No. 10,563,133 granted 18 Feb. 2020; U.S. application Ser. No. 16/103,895 is a continuation-in-part of PCT/US2018/017863 filed 12 Feb. 2018, which claims benefit of U.S. Provisional Application No. 62/589,479, filed 21 Nov. 2017 and claims benefit of U.S. Provisional Application No. 62/458,002, filed 12 Feb. 2017; and U.S. application Ser. No. 16/103,895 is a continuation-in-part of PCT/US2018/017855 filed 12 Feb. 2018, which claims benefit of U.S. Provisional Application No. 62/589,479, filed 21 Nov. 2017 and claims benefit of U.S. Provisional Application No. 62/458,002, filed 12 Feb. 2017; and, D) application Ser. No. 17/856,853 is a continuation-in-part of co-pending U.S. application Ser. No. 16/103,884, filed 14 Aug. 2018; U.S. application Ser. No. 16/103,884 is a continuation-in-part of PCT/US2018/017863 filed 12 Feb. 2018, which claims benefit of U.S. Provisional Application No. 62/589,479, filed 21 Nov. 2017 and claims benefit of U.S. Provisional Application No. 62/458,002, filed 12 Feb. 2017; and U.S. application Ser. No. 16/103,884 is a continuation-in-part of PCT/US2018/017855 filed 12 Feb. 2018, which claims benefit of U.S. Provisional Application No. 62/589,479, filed 21 Nov. 2017 and claims benefit of U.S. Provisional Application No. 62/458,002, filed 12 Feb. 2017. As such, this application may be seen as a consolidation of, and thereby a continuation-in-part of each of the above noted applications, further this Application expressly incorporates by reference, all of the foregoing referenced applications and granted patents in their entirety.

### BACKGROUND

There are two basic marine fuel types, the specifications for which are set forth in ISO 8217:2017; distillate marine fuel (Table 1), and residual marine fuel (Table 2). Distillate marine fuel, also known as Marine Gas Oil (MGO) or Marine Diesel Oil (MDO) comprises kerosene, diesel and gas oil petroleum fractions separated from crude oil in a refinery. Gas oil (also known as medium diesel) is a petroleum fraction intermediate in boiling range and viscosity between kerosene and lubricating oil containing a mixture of mostly paraffinic C10-C19 hydrocarbons. Gas oil is used to heat homes and is used for heavy equipment such as cranes, bulldozers, generators, bobcats, tractors and combine harvesters. Generally maximizing gasoil recovery from heavier oil fractions is the most economic use of the petroleum oil by refiners. Diesel oils are very similar to gas oils with diesel containing predominantly contain a mixture of C10 through C19 hydrocarbons, which include approximately 60% or more aliphatic hydrocarbons, about 1-2% olefinic hydrocarbons, and approximately 35% or less aromatic hydrocarbons. Diesel fuels are primarily utilized as a land transport fuel and as blending component with kerosene to form aviation jet fuel, however on ships diesel fuel may be utilized to run generators and other secondary machinery, but rarely the main propulsion units (i.e. ship engines) because of the cost for fuel. The art of removing Environmental Contaminants (as defined below) from light gas oils and/or kerosene or diesel (collectively and colloquially known as “distillate”) is well developed and known and is not the focus of the present invention.

Residual marine fuels or Heavy Marine Fuel Oil (HMFO) are distinctly different from distillate marine fuels, as is noted in ISO 8217:2017. The HMFOs are compliant with the requirements of Table 2 of ISO 8217:2017 (making them residual marine fuels) and the later are compliant with the requirements of Table 1 of ISO 8217:2017 (making them distillate marine fuels). As a practical matter, and as one of skill in the art would know, a marine fuel compliant with ISO 8217:2017 Table 2, cannot be sold as a distillate marine fuel compliant with ISO 8217:2017 Table 1. Similarly, a marine fuel compliant with ISO 8217:2017 Table 1 as a distillate marine fuel would never be sold or marketed as an ISO 8217:2017 Table 2 residual marine fuel because doing so would make no economic sense; the distillate marine fuel is far more valuable than residual marine fuel, distillate marine fuels are less energy dense (i.e. generate less usable energy per unit of fuel) than residual marine fuels, and a ship's prime mover engines are generally not designed to operate on Table 1 distillate marine fuels without modifications or operational changes. ISO 8217:2017 Table 2 compliant residual marine fuels (a term Applicant herein uses interchangeably with Heavy Marine Fuel Oil (HMFO)) are a complex mixture of hydrocarbons, often heavy or vacuum gas oils mixed with heavier (higher boiling point) oils and/or hydrocarbon residues-the fractions having a boiling point greater than gas oils, and that are so heavy they may not boil or vaporize under atmospheric pressure or even under vacuum conditions. These heavy oil fractions (sometimes colloquially called residue or resid) often contain asphaltenes and resins between 3 and 20 percent by weight or greater. Asphaltenes are large and complex polycyclic hydrocarbons that are believed to contribute to the fuel energy density, SARA properties, and lubricity properties of HMFO which are commercially desirable. Asphaltenes and resins in heavy oil fractions however, have a propensity to form complex and waxy precipitates, especially when mixed with or in the presence with aliphatic (paraffinic) hydrocarbons such as those that make up the majority of “distillate” hydrocarbon fractions. Once asphaltenes have precipitated out, they are notoriously difficult to re-dissolve and are colloquially described as fuel tank sludge in the marine shipping industry and marine bunker fueling industry.

Large ocean-going ships have relied upon HMFO to power large two stroke diesel engines for over 50 years. HMFO is a complex blend of aromatics, polycyclic aromatics, heavy (high boiling point) distillates, resins, and other uncharacterized hydrocarbons (i.e. residues) generated in the crude oil refinery process; the exact nature of the components is highly dependent upon the refinery and refinery crude slate. Typical refinery streams included in the formulation of HMFO include: atmospheric tower bottoms (i.e. atmospheric residues), vacuum tower bottoms (i.e. vacuum residues) visbreaker residue, FCC Light Cycle Oil (LCO), FCC Heavy Cycle Oil (HCO) also known as FCC bottoms, FCC Slurry Oil also known as decant oil, heavy gas oils, delayed coker oils (DCO), polycylic aromatic hydrocarbons, De-asphalted oils (DAO), reclaimed or reprocessed land transport motor oils, heavy residual oil fractions created throughout the refinery and petrochemical complex, and limited portions (often less than 20% by volume) of cutter oils, kerosene or diesel to achieve a desired viscosity. HMFO has an aromatic content higher than the marine distillate fuels noted above. The HMFO composition is complex and varies with the source of crude oil as well as the refinery processes utilized in a particular refinery to extract the most value out of a barrel of crude oil and are sometimes derisively called “the bottom of the barrel”. It well known in the art of formulating HSFO for commercial use to determine the known properties of each hydrocarbon component, and then optimize the ratio of available components in a blend to achieve a desired final blend with the desired commercial properties (such as those in ISO 8217 Table 2). However, blending of heavy hydrocarbons is a delicate and unpredictable process because of the presence of asphaltenes and resins that can precipitate out over time. The mixture of hydrocarbon components is generally characterized as being a wide range of hydrocarbons having high boiling points, often uncharacterized chemically, resulting in a hydrocarbon cocktail that is viscous, high in sulfur and metal content, and high in asphaltenes making HMFO the one of the few, if not the only product of the refining process that has a per barrel value less than the feedstock crude oil itself. Often HMFO is the repository of “left over” hydrocarbon fractions from which a refiner can no longer economically extract any further valuable hydrocarbon fractions.

Industry statistics indicate that about 90% of the HMFO sold contains 3.5 weight % sulfur. With an estimated total worldwide consumption of HMFO of approximately 300 million tons per year, the annual production of sulfur dioxide by the shipping industry is estimated to be over 21 million tons per year. Emissions from HMFO burning in ships contribute significantly to both global air pollution and local air pollution levels.

MARPOL, the International Convention for the Prevention of Pollution from Ships, as administered by the International Maritime Organization (IMO) was enacted to prevent pollution from ships. In 1997, a new annex was added to MARPOL; the Regulations for the Prevention of Air Pollution from Ships—Annex VI to minimize airborne emissions from ships and their contribution to air pollution. A revised Annex VI with tightened emissions limits on sulfur oxides, nitrogen oxides, ozone depleting substances and volatile organic compounds (SOx, NOx, ODS, VOC) was adopted in October 2008 and effective 1 Jul. 2010 (hereafter called Annex VI (revised)).

MARPOL Annex VI (revised) established a set of stringent emissions limits for vessel operations in designated Emission Control Areas (ECAs). The ECAs under MARPOL Annex VI (revised) are: i) Baltic Sea area—as defined in Annex I of MARPOL—SOx only; ii) North Sea area—as defined in Annex V of MARPOL—SOx only; iii) North American—as defined in Appendix VII of Annex VI of MARPOL—SOx, NOx and PM; and, iv) United States Caribbean Sea area—as defined in Appendix VII of Annex VI of MARPOL—SOx, NOx and PM.

Annex VI (revised) was codified in the United States by the Act to Prevent Pollution from Ships (APPS). Under the authority of APPS, the U.S. Environmental Protection Agency (the EPA), in consultation with the United States Coast Guard (USCG), promulgated regulations which incorporate by reference the full text of MARPOL Annex VI (revised). See 40 C.F.R. § 1043.100 (a) (1). On Aug. 1, 2012 the maximum sulfur content of all marine fuel oils used onboard ships operating in US waters/ECA cannot exceed 1.00% wt. (10,000 ppm) and on Jan. 1, 2015 the maximum sulfur content of all marine fuel oils used in the North American ECA was lowered to 0.10% wt. (1,000 ppm). At the time of implementation, the United States government indicated that vessel operators must vigorously prepare for the 0.10% wt. (1,000 ppm) US ECA marine fuel oil sulfur standard. To encourage compliance, the EPA and USCG refused to consider the cost of compliant low sulfur fuel oil to be a valid basis for claiming that compliant fuel oil was not available for purchase. For the past five years there has been a very strong economic incentive to meet the marine industry demands for low sulfur HMFO, however technically viable solutions have not been realized. There has been an on-going and urgent demand for processes and methods for making a low sulfur HMFO that is compliant with MARPOL Annex VI emissions requirements, especially the strict MARPOL ECA requirements.

Under the revised MARPOL Annex VI, the global sulfur cap for HMFO was reduced to 3.50% wt. effective 1 Jan. 2012; then further reduced to 0.50% wt, effective 1 Jan. 2020. This regulation has been the subject of much discussion in both the marine shipping and marine fuel bunkering industry. There has been a very strong economic incentive to meet the international marine industry demands for low sulfur HMFO that is compliant with ISO 8217:2017 Table 2 as a residual marine fuel, however technically viable solutions have not been realized. There is an on-going and urgent demand for processes and methods for making a low sulfur HMFO that is compliant with both the MARPOL Annex VI emissions requirements and ISO 8217 Table 2.

Primary control solutions: A focus for compliance with the MARPOL requirements has been on primary control solutions for reducing the sulfur levels in marine fuel components prior to combustion based on the substitution of HMFO with alternative fuels. Because of the potential risks to ships propulsion systems (i.e. fuel systems, engines, etc.) when a ship switches fuel, the conversion process must be done safely and effectively to avoid any technical issues. However, each alternative fuel has both economic and technical difficulties adapting to the decades of shipping infrastructure and bunkering systems based upon HMFO utilized by the marine shipping industry.

LNG: The most prevalent primary control solution in the shipping industry is the adoption of LNG as a primary or additive fuel to HMFO. An increasing number of ships are using liquified natural gas (LNG) as a primary fuel. Natural gas as a marine fuel for combustion turbines and in diesel engines leads to negligible sulfur oxide emissions. The benefits of natural gas have been recognized in the development by IMO of the International Code for Ships using Gases and other Low Flashpoint Fuels (the IGF Code), which was adopted in 2015. LNG however presents the marine industry with operating challenges including: on-board storage of a cryogenic liquid in a marine environment will require extensive renovation and replacement of the bunker fuel storage and fuel transfer systems of the ship; the supply of LNG is far from ubiquitous in major world ports; updated crew qualifications and training on operating LNG or duel fuel engines will be required prior to going to sea.

Sulfur Free Bio-fuels: Another proposed primary solution for obtaining compliance with the MARPOL requirements is the substitution of HMFO with sulfur free bio-fuels. Bio-diesel has had limited success in displacing petroleum derived diesel however supply remains constrained. Methanol has been used on some short sea services in the North Sea ECA on ferries and other littoral ships. The widespread adoption of bio-fuel, such as bio-diesel or methanol, present many challenges to ship owners and the bunker fuel industry. These challenges include: fuel system compatibility and adaptation of existing fuel systems will be required; contamination during long term storage of methanol and biodiesel from water and biological contamination; the heat content of methanol and bio-diesel on a per ton basis is substantially lower than HMFO; and methanol has a high vapor pressure and presents serious safety concerns of flash fires.

Replacement of heavy fuel oil with marine gas oil or marine diesel: Another proposed primary solution is to simply replace HMFO with marine gas oil (MGO) or marine diesel (MDO). As noted above, the first major difficulty is the constraint in global supply of the hydrocarbon fraction that make up over 90% vol of MGO and MDO. It is reported that the effective spare capacity to produce MGO is less than 100 million metric tons per year resulting in an annual shortfall in marine fuel of over 200 million metric tons per year. Refiners not only lack the capacity to increase the production of lower value MGO, but they have no economic motivation because higher value and higher margins can be obtained from ultra-low sulfur diesel fuel for land-based transportation systems (i.e. trucks, trains, mass transit systems, heavy construction equipment, etc.). Lastly, and most importantly from a refiner's perspective, a distillate only solution ignores the economic impact of disposing of the refinery streams that previously went to the high sulfur HMFO blending pool.

Blending: Another primary solution is the blending of one or more of the higher sulfur components of HMFO with lower sulfur containing fuels such as low sulfur marine diesel (0.1% wt. sulfur) to achieve a Product HMFO with a sulfur content of 0.5% wt. This involves the application of the well-known results driven optimized blending processes in which the properties (including sulfur content) of the starting materials are known and blending simply becomes and exercise in achieving a compliant (ie. less than 0.5wt % sulfur) blend for the least cost. For example, in a hypothetical straight blending approach (based on simple linear blending) every 1 ton of HSFO (3.5% sulfur) requires 7.5 tons of MGO or MDO material with 0.1% wt. S to achieve a sulfur level of 0.5% wt. HMFO. One of skill in the art of fuel blending will immediately understand that blending is a balancing of properties between the components and key properties required of a HMFO compliant ISO 8217:2017 Table 2, specifically viscosity, density, CCAI, flash point, pour point, potential sediment, and solids content can be substantially altered and adversely affected in unpredictable ways by the optimized blending process. Further a blending process may result in a fuel with variable viscosity and density resulting in inherent instability during storage, such that that final fuel delivered to the customer may no longer meet the requirements for a HMFO.

Further complications may arise when blended HMFO is introduced into the bunkering infrastructure and shipboard systems otherwise designed for unblended HMFO. There is a real risk of incompatibility when the two fuels are mixed. Blending a mostly paraffinic-type distillate fuel (MGO or MDO) with a HMFO having a high aromatic content often correlates with poor solubility of asphaltenes. A blended fuel is likely to result in the precipitation of asphaltenes and/or highly paraffinic materials from the distillate material forming an intractable fuel tank sludge. Fuel tank sludge causes clogging of fuel filters and separators, transfer pumps and lines, build-up of sludge in storage tanks, sticking of fuel injection pumps (deposits on plunger and barrel), and plugged fuel nozzles. Such a risk to the primary propulsion system is not acceptable for a cargo ship in the open ocean.

Lastly blending of HMFO with marine distillate products (MGO or MDO) is not economically feasible. A blender will be taking a high value product (0.1% S marine gas oil (MGO) or marine diesel (MDO)) and blending it 7.5 to 1 with a low value high sulfur HMFO to create a final IMO/MARPOL compliant HMFO (i.e. 0.5% wt. S Low Sulfur Heavy Marine Fuel Oil—LSHMFO). It is expected that LSHMFO will sell at a lower price on a per ton basis than the value of the two blending stocks alone.

Processing of heavy oils. For the past several decades, the focus of refining industry research efforts related to the processing of heavy oils (heavy crude oils, bitumen, distressed oils, or residual oils) has been on upgrading the properties of these low value refinery process oils to create lighter oils with greater value. The challenge has been that heavy oils can be unstable (depending upon the source or process that created them) and contain high levels of sulfur, nitrogen, phosphorous, metals (especially vanadium and nickel) and asphaltenes. Much of the nickel and vanadium is in difficult to remove chelates with porphyrins. Vanadium and nickel porphyrins and other metal organic compounds are responsible for catalyst contamination and corrosion problems in the refinery. The sulfur, nitrogen, and phosphorous, are removed because they are well-known poisons for the precious metal (platinum and palladium) catalysts utilized in the processes downstream of the atmospheric or vacuum distillation towers.

The difficulties treating heavy oils, such as atmospheric or vacuum residual streams or thermally cracked oil, has been known for many years and has been the subject of considerable research and investigation. Numerous heavy oil conversion processes have been developed in which the goals are same, 1) create a more valuable, preferably distillate range hydrocarbon product; and 2) concentrate the contaminates such as sulfur, nitrogen, phosphorous, metals and asphaltenes into a form (coke, heavy coker residue, FCC slurry oil) for removal from the refinery stream. Well known and accepted practice in the refining industry is to increase the reaction severity (elevated temperature and pressure) to produce hydrocarbon products that are lighter and more purified, increase catalyst lifetimes and remove sulfur, nitrogen, phosphorous, metals and asphaltenes from the refinery stream. It is also well known in these processes that the nature of the heavy oil feedstock has a significant influence upon the products produced, catalyst life, and ultimately the economic viability of the process. In a representative technical paper Residual-Oil Hydrotreating Kinetics for Graded Catalyst Systems: Effects of Original and Treated Feedstocks, is stated that “The results revealed significant changes in activity, depending on the feedstock used for the tests. The study demonstrates the importance of proper selection of the feedstocks used in the performance evaluation and screening of candidate catalyst for graded catalyst systems for residual-oil hydrotreatment.” From this one skilled in the art would understand that the conditions required for the successful hydroprocessing of atmospheric residue are not applicable for the successful hydroprocessing of vacuum residue which are not applicable for the successful hydroprocessing of a visbreaker residue, and so forth. Successful reaction conditions depend upon the nature of the heavy oil feedstock. For this reason, modern complex refineries often have multiple hydroprocessing units, each unit being targeted on specific heavy oil hydrocarbon stream with a focus on creating the desirable and valuable light hydrocarbons and providing a product acceptable to the next downstream process.

A further difficulty in the processing of heavy oil and other heavy residual hydrocarbons is the inherent instability of these refinery streams. One of skill in the art understands there are many practical reasons each refinery stream is handled in isolation. One such reason is the unpredictable nature of the asphaltenes contained in each stream. Asphaltenes are large and complex hydrocarbons with a propensity to precipitate out of refinery hydrocarbon streams. One of skill in the art knows that even small changes in the components or physical conditions (temperature, pressure) can precipitate asphaltenes that were otherwise dissolved in solution. Once precipitated from solution, asphaltenes can quickly block vital lines, control valves, coat critical sensing devices (i.e. temperature and pressure sensors) and generally result in the severe and very costly disruption and shut down of a unit or the whole refinery. For this reason, it has been a long-standing practice within refineries to not blend intermediate product streams (such as atmospheric residue, vacuum residue, FCC slurry oil, etc. . . . ) and process each stream in separate reactors. In summary, since the announcement of the MARPOL standards reducing the global levels of sulfur in HMFO, refiners of crude oil have had only limited success in the technical efforts to create a process for the production of a low sulfur substitute for HMFO. Despite the strong governmental and economic incentives and needs of the international marine shipping industry, refiners have little economic reason to address the removal of Environmental Contaminants from HMFOs. Instead, the global refining industry has been focused upon generating greater value from each barrel of oil by creating light hydrocarbons (i.e. diesel and gasoline) and concentrating the Environmental Contaminants into increasingly lower value streams (i.e. residues) and products (petroleum coke, HMFO). Shipping companies have focused on short term solutions, such as the installation of scrubbing units, or adopting the limited use of more expensive low sulfur marine diesel and marine gas oils as a substitute for HMFO. On the open seas, most if not all major shipping companies continue to utilize the most economically viable fuel, that is HMFO. There remains a long standing and unmet need for processes and devices that remove the Environmental Contaminants (i.e. organic and inorganic chemical species within the HMFO resulting in measurable amounts of sulfur, nitrogen, phosphorous, metals especially vanadium and nickel, iron, aluminum and silicon) from HMFO without altering the qualities and properties that make HMFO the most economic and practical means of powering ocean going vessels. Further there remains a long standing and unmet need for IMO compliant low sulfur (i.e. 0.5% wt. sulfur) or ultralow (0.10 wt. sulfur) HMFO that is also compliant with the bulk properties required by ISO 8217 Table 2, and be stable, and compatible and thus merchantable and suitable for its intended use in for the marine shipping industry.

### SUMMARY

It is a general objective to process a high sulfur Feedstock Heavy Marine Fuel Oil (HMFO) compliant with ISO8217: 2017 Table 2 as a residual marine fuel in a multi stage process that minimizes the changes in the desirable properties of the HMFO and minimizes the production of by-product hydrocarbons (i.e. light hydrocarbons having C₁-C₄ and wild naphtha, i.e. hydrocarbons having a boiling point less than 150 F) but reduces the sulfur and other Environmental Contaminants present in the Feedstock HMFO.

A first aspect and illustrative embodiment encompasses a multi-stage process for the production of a low sulfur Product Heavy Marine Fuel Oil, the process involving: mixing a quantity of the Feedstock Heavy Marine Fuel Oil with a quantity of Activating Gas to give a Feedstock Mixture; contacting the Feedstock Mixture with one or more catalysts in a Reaction System under reactive conditions, preferably reactive distillation conditions to form a Process Mixture from the Feedstock Mixture, wherein the one or more catalysts are in a structured catalyst bed; receiving the Process Mixture and separating the Product Heavy Marine Fuel Oil liquid components of the Process Mixture from the gaseous components and by-product hydrocarbon components of the Process Mixture and, discharging the Product Heavy Marine Fuel Oil. In a preferred embodiment, the Reaction System comprises two or more reactor vessel wherein one or more of the reactor vessels contains a structured catalyst bed. In one embodiment, the structured catalyst bed comprises a plurality of catalyst retention structures, each catalyst retention structure composed of a pair of fluid permeable corrugated metal sheets, wherein the pair of the fluid permeable corrugated metal sheets are aligned so the corrugations are out of phase and defining a catalyst rich space and a catalyst lean space within the structured catalyst bed, wherein within the catalyst rich space there is one or more catalyst materials and optionally inert packing materials. Another alternative and embodiment the structured catalyst bed contains one or more catalysts to promote the transformation of the Feedstock mixture to a Process Mixture wherein the structured catalyst bed comprises a plurality of catalyst retention structures, each catalyst retention structure composed of a pair of fluid permeable corrugated metal sheets, wherein the pair of the fluid permeable corrugated metal sheets are aligned so the corrugations are out of phase and defining a catalyst rich space and a catalyst lean space within the structured catalyst bed, wherein within the catalyst rich space there is one or more catalyst materials and optionally inert packing materials.

A second aspect and illustrative embodiment encompasses a device or plant for the production of a Product HMFO. The illustrative devices embody the above illustrative processes on a commercial scale. Such devices include the use of multiple reactor vessels forming a Reactor System in which at least one or more of the reactor vessels operates under reactive distillation conditions and contains a structured catalyst bed.

A third aspect and illustrative embodiment encompasses a reaction vessel containing one or more structured catalyst beds and preferably configured to operate under reactive distillation conditions so at least 50% and preferably at least 75% and more preferably at least 90% of the desired reaction products that have a higher boiling point than the by-products present in the reaction mixture, as illustrated in the present application pertaining to HMFO, having a boiling point greater than 150 F exit the lower portion of the reactor vessel. This is in marked contrast to the more common reactive distillation processes known in the art, in which the desired reaction products are distilled from the by-product products with the desired reaction products exiting the top or middle of the reaction vessel and the by-products and feedstock materials exiting the lower or bottom of the reaction vessel.

A third aspect and illustrative embodiment encompasses one or more internal structures within the interior space of the reaction vessel. Preferably the internal structures include one or more structured catalyst beds containing one or more catalyst to promote the transformation of the Feedstock Mixture to the Process Mixture under reactive conditions. The internal structures may be installed, removed or replaced either as individual structures or as a whole. The structures may contain pre-activated catalyst, as illustrated by the present invention's disclosure of pre-sulfided hydrotreating catalyst, that may be passivated with temporary protective coatings to facilitate handing, transport and storage without adversely impacting the catalytic activity.

### DESCRIPTION OF DRAWINGS

FIG. 1 is a process block flow diagram of an illustrative core process to produce Product HMFO.

FIG. 2 is a process flow diagram of a multistage process for transforming the Feedstock HMFO and a subsequent core process to produce Product HMFO.

FIG. 3 is a process flow diagram of a first alternative configuration for the Reactor System (11) in FIG. 2.

FIG. 4 is a process flow diagram of a second alternative configuration for the Reactor System (11) in FIG. 2.

FIG. 5 is a side view of a catalyst retention structure component of a first illustrative embodiment of a structured catalyst bed.

FIG. 6 is a side view of a first illustrative embodiment of a structured catalyst bed.

FIG. 7 is a side view of a catalyst retention structure component of a second illustrative embodiment of a structured catalyst bed.

FIG. 8 is a side view of a second illustrative embodiment of a structured catalyst bed.

FIG. 9 illustrates a reaction vessel configured to operate under reactive distillation conditions.

### DETAILED DESCRIPTION:

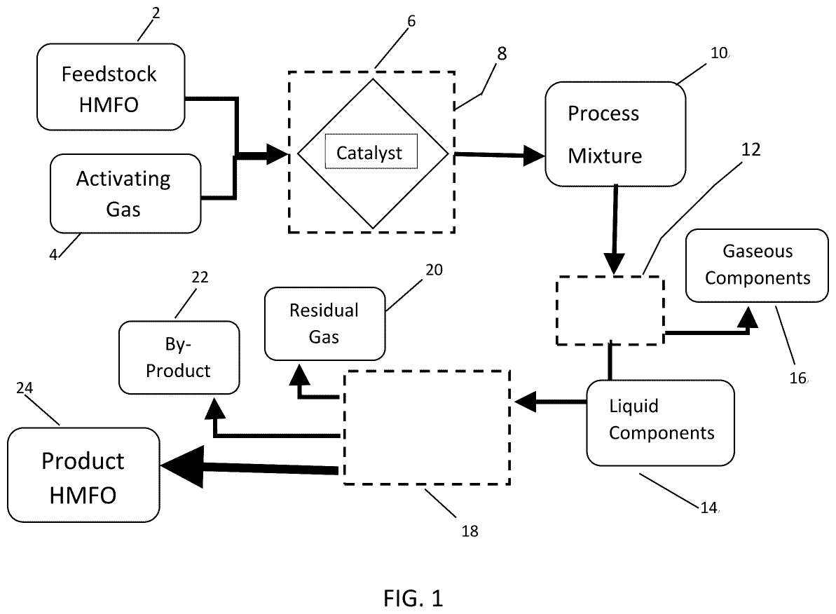

The inventive concepts as described herein utilize terms that should be well known to one of skill in the art, however certain terms are utilized having a specific intended meaning and these terms are defined below:
Heavy Marine Fuel Oil (HMFO) is a petroleum product fuel compliant with the ISO 8217:2017 Table 2 standards for the properties of residual marine fuel but may or may not be compliant with the required concentration levels of the Environmental Contaminants.
Environmental Contaminants are organic and inorganic chemical species of HMFO that result in the formation of SOx, NOx and particulate materials upon combustion, more specifically organic and inorganic compounds within the HMFO resulting in measurable amounts of sulfur, nitrogen, phosphorus, vanadium, nickel, iron, aluminum and silicon.
Feedstock HMFO is a petroleum product fuel compliant with the ISO 8217:2017 Table 2 standards for the properties of residual marine fuels except for the concentration of Environmental Contaminants, preferably the Feedstock HMFO has a sulfur content greater than the global MARPOL standard of 0.5% wt. sulfur, and preferably and has a sulfur content (ISO 14596 or ISO 8754) between the range of 5.0% wt. to 1.0% wt. It should be noted that it is not a requirement of the Feedstock HMFO to be of merchantable quality as that term is used in this Application; one surprising and unexpected aspect of this invention is that hydroprocessing the Feedstock HMFO appears to impart properties of fungibility (i.e. compatibility, miscibility and stability over time with other marine fuels) to the Product HMFO that may not be necessarily present in the Feedstock HMFO.
Product HMFO is a petroleum product fuel compliant with the ISO 8217:2017 Table 2 standards for the properties of residual marine fuels and achieves a sulfur content lower than the global MARPOL standard of 0.5% wt. sulfur (ISO 14596 or ISO 8754), and preferably a maximum sulfur content (ISO 14596 or ISO 8754) between the range of 0.05% wt. to 1.0% wt. The Product HMFO has been found to be of merchantable quality as that term is used in this Application; that is one surprising and unexpected aspect of this invention is that hydroprocessing appears to impart properties of fungibility (i.e. compatibility, miscibility and stability over time with other marine fuels) to the Product HMFO, a property that may not be necessarily present in the Feedstock HMFO.
Activating Gas: is a mixture of gases utilized in the process combined with the catalyst to remove the Environmental Contaminants from the Feedstock HMFO. Activating Gas is defined in greater technical detail below.
Fluid communication: is the capability to transfer fluids (either liquid, gas or combinations thereof, which might have suspended solids) from a first vessel or location to a second vessel or location, this may encompass connections made by pipes (also called a line), spools, valves, intermediate holding tanks or surge tanks (also called a drum).
Merchantable quality: is a level of quality for a residual marine fuel so that the fuel is fit for the ordinary purpose it is intended to serve (i.e. serve as a residual marine fuel for a marine ship) and can be commercially sold as such, and that is fungible (i.e. compatible, miscable and stable over time) with other residual marine fuels and distillate marine fuels.
Bbl or bbl: is a standard volumetric measure for oil; 1 bbl=0.1589873 m3; or 1 bbl=158.9873 liters; or 1 bbl=42.00 US liquid gallons.
Bpd: is an abbreviation for Bbl per day.
SCF: is an abbreviation for standard cubic foot of a gas; a standard cubic foot (at 14.73 psi and 60° F.) equals 0.0283058557 standard cubic meters (at 101.325 kPa and 15° C.). 037. The inventive concepts are illustrated in more detail in this description referring to the drawings, in which FIG. 1 shows the generalized block process flows for a core process of reducing the Environmental Contaminants in a Feedstock HMFO (as defined above and herein (i.e. compliant with ISO 8217:2017 Table 2 as a residual marine fuel except for Environmental Contaminants level) and producing a Product HMFO (as defined above and herein) that is compliant with ISO 8217:2017 Table 2 as a residual marine fuel. A predetermined volume of Feedstock HMFO (2) is mixed with a predetermined quantity of Activating Gas (4) to give a Feedstock Mixture. The Feedstock HMFO utilized generally complies with the physical and chemical properties for a residual marine fuel oil otherwise compliant with ISO 8217:2017 Table 2 as a residual marine fuel exclusive of the Environmental Contaminates. More particularly, when the Environmental Contaminates is measured by sulfur, the concentration of sulfur in the Feedstock HMFO may be greater than 0.5wt %, for example between the range of 5.0% wt. to 1.0% wt. The Feedstock HMFO should have physical properties required of an ISO 8217:2017 compliant HMFO. The Feedstock HMFO should exhibit the bulk properties of: a maximum of kinematic viscosity at 50° C. (ISO 3104) between the range from 180 mm²/s to 700 mm²/s; a maximum of density at 15° C. (ISO 3675) between the range of 991.0 kg/m³ to 1010.0 kg/m3; a CCAI in the range of 780 to 870; and a flash point (ISO 2719) no lower than 60° C. Properties of the Feedstock HMFO connected to the formation of particulate material (PM) include: a total sediment—aged (ISO 10307-2) less than 0.10% wt. and a carbon residue—micro method (ISO 10370) less than 20% wt. and preferably an aluminum plus silicon (ISO 10478) content of less than 60 mg/kg. Environmental Contaminants other than sulfur that may be present in the Feedstock HMFO over the ISO requirements may include vanadium, nickel, iron, aluminum and silicon substantially reduced by the process of the present invention. One of skill in the art will appreciate that the vanadium content serves as a general indicator of these other metallic Environmental Contaminates. In one preferred embodiment the vanadium content is compliant with ISO 8217:2017 Table 2 as a residual marine fuel so the Feedstock HMFO has a maximum vanadium content (ISO 14597) between the range from 350 mg/kg to 450 ppm mg/kg. However, in another embodiment the vanadium content exceeds the requirements of ISO 8217:2017 Table 2 and the Feedstock HMFO has a vanadium content (ISO 14597) in excess of 450 ppm mg/kg. and this is reduced to within acceptable limits by Applicant's process.

As for the properties of the Activating Gas, the Activating Gas should be selected from mixtures of nitrogen, hydrogen, carbon dioxide, gaseous water, and methane. The mixture of gases within the Activating Gas should have an ideal gas partial pressure of hydrogen (p_{H2}) greater than 90% of the total pressure of the Activating Gas (P) and more preferably wherein the Activating Gas has an ideal gas partial pressure of hydrogen (p_{H2}) greater than 95% of the total pressure of the Activating Gas (P). It will be appreciated by one of skill in the art that the molar content of the Activating Gas is another criterion the Activating Gas should have a hydrogen mole fraction in the range between 80% and 100% of the total moles of Activating Gas, more preferably wherein the Activating Gas has a hydrogen mole fraction between 80% and 99% of the total moles of Activating Gas.

In one embodiment the Feedstock Mixture (i.e. mixture of Feedstock HMFO and Activating Gas) is brought up to the process reactive conditions of temperature and pressure and introduced into a Reactor System, preferably one or more reactor vessels. The Feedstock Mixture is then contacted with one or more catalysts (8) under conditions suitable for removal of the Environmental Contaminants via hydrotreating, more specifically hydrodemetallization and/or hydrodesulfurization, but preferably not conditions of hydrocracking, to form a Process Mixture from the Feedstock Mixture.

The core process reactive conditions are selected so the ratio of the quantity of the Activating Gas to the quantity of Feedstock HMFO is 250 scf gas/bbl of Feedstock HMFO to 10,000 scf gas/bbl of Feedstock HMFO; and preferably between 2000 scf gas/bbl of Feedstock HMFO 1 to 5000 scf gas/bbl of Feedstock HMFO more preferably between 2500 scf gas/bbl of Feedstock HMFO to 4500 scf gas/bbl of Feedstock HMFO. The process conditions are selected so the total pressure in the first vessel is between of 250 psig and 3000 psig; preferably between 1000 psig and 2500 psig, and more preferably between 1500 psig and 2200 psig. The process reactive conditions are selected so the indicated temperature within the first vessel is between of 500° F. to 900° F., preferably between 650° F. and 850° F. and more preferably between 680° F. and 800° F. The process conditions are selected so the liquid hourly space velocity within the first vessel is between 0.05 oil/hour/m³ catalyst and 1.0 oil/hour/m³ catalyst; preferably between 0.08 oil/hour/m³catalyst and 0.5 oil/hour/m³ catalyst; and more preferably between 0.1 oil/hour/m³catalyst and 0.3 oil/hour/m³ catalyst to achieve deep desulfurization with product sulfur levels below 0.1 ppmw. These conditions can be further optimized to be reactive distillation conditions such that the lighter by-product hydrocarbons (i.e. hydrocarbons having a boiling point less than 150 F) and gases contained in the Process Mixture are separated via vaporization (i.e. distillation) from the Product HMFO which remains in a liquid phase.

One of skill in the art will appreciate that the process reactive distillation conditions are in part determined by considering the hydraulic capacity of the unit. Exemplary hydraulic capacity for the treatment unit may be between 100 bbl of Feedstock HMFO/day and 100,000 bbl of Feedstock HMFO/day, preferably between 1000 bbl of Feedstock HMFO/day and 60,000 bbl of Feedstock HMFO/day, more preferably between 5,000 bbl of Feedstock HMFO/day and 45,000 bbl of Feedstock HMFO/day, and even more preferably between 10,000 bbl of Feedstock HMFO/day and 30,000 bbl of Feedstock HMFO/day.

One of skill in the art will appreciate that a fixed bed supported transition metal heterogeneous catalyst will be the technically easiest to implement and thus is preferred. However liquid catalyst or bulk catalyst additive may prove to be advantageous with certain Feedstock HMFO. Other alternative reactor types may be utilized including, but not limited to: ebulliated or fluidized bed reactors; structured bed reactors; three-phase bubble reactors; reactive distillation bed reactors and the like all of which may be co-current or counter current. It is also contemplated that high flux or liquid full type reactors may be used such as those disclosed in U.S. Pat. Nos. 6,123,835; 6,428,686; 6,881,326; 7,291,257; 7,569,136 and other similar and related patents and patent applications all of which are incorporated by reference.

The transition metal heterogeneous catalyst utilized comprises a porous inorganic oxide catalyst carrier and a transition metal catalytic metal impregnated into or onto the carrier. The porous inorganic oxide catalyst carrier is at least one carrier selected from the group consisting of alumina, alumina/boria carrier, a carrier containing metal-containing aluminosilicate, alumina/phosphorus carrier, alumina/alkaline earth metal compound carrier, alumina/titania carrier and alumina/zirconia carrier. The transition metal catalytic metal component of the catalyst is one or more metals selected from the group consisting of group 6, 8, 9 and 10 of the Periodic Table. In a preferred and illustrative embodiment, the transition metal heterogeneous catalyst is a porous inorganic oxide catalyst carrier and a transition metal catalyst, in which the preferred porous inorganic oxide catalyst carrier is alumina and the preferred transition metal catalyst is Ni—Mo, Co—Mo, Ni—W or Ni—Co—Mo. The process by which the transition metal heterogeneous catalyst is manufactured is known in the literature and preferably the catalysts are commercially available as hydrodemetallization catalysts, hydro-transition catalysts, hydrodesulfurization catalyst and combinations of these which may or may no be pre-sulfided. The transition metal heterogeneous catalyst is part of a structured catalyst bed in which the catalyst particles are distributed within an otherwise inert supporting structure to achieve an optimized balance between catalyst activity per unit volume and the linear space velocity of the Feedstock Mixture. This is described in greater detail below in relation to the structured catalyst bed configuration itself.

The Process Mixture (10) under reactive distillation conditions remains in one or more of the reactions vessels in the Reactor System (8) and may remain being in contact with the one or more catalyst. This facilitates the separation of the gases and by-product hydrocarbons (i.e. hydrocarbons having a boiling point less than 150 F) to produce a stream of Product HMFO exiting the bottom of the reaction vessel. The Product HSFO may be sent via fluid communication to a second vessel (12), preferably a gas-liquid separator or hot separators and cold separators, for further separating any remaining the liquid components (14) of the Process Mixture or gaseous components (16) of the Process Mixture from the Product HMFO. The gaseous components (16) are treated beyond the battery limits of the immediate process. Such gaseous components may include a mixture of Activating Gas components and lighter hydrocarbons (mostly methane, ethane and propane but some wild naphtha, all having a boiling point less than 150 F) that may have been formed as part of the by-product hydrocarbons from the process.

045. The Liquid Components (16) in this core process may optionally be sent via fluid communication to a third vessel (18), preferably a fuel oil product stripper system, for separating any residual gaseous components (20) and by-product hydrocarbon components (22) from the Product HMFO (24). The residual gaseous components (20) may be a mixture of gases selected from the group consisting of: nitrogen, hydrogen, carbon dioxide, hydrogen sulfide, gaseous water, C₁-C₅ hydrocarbons. This residual gas is treated outside of the battery limits of the immediate process, combined with other gaseous components (16) removed from the Process Mixture (10) in the second vessel (12). The liquid by-product hydrocarbon components, which may be condensable hydrocarbons unavoidably formed in the process (22) may be a mixture of hydrocarbons such a wild naphtha and light diesel having a boiling point less than 150° F., that for example can be sent to the gasoline motor fuel blending pool or sold as gasoline and diesel blending components on the open market. Any liquid by-product hydrocarbons which result from hydrocracking should be less than 15% wt., preferably less than 5% wt. and more preferably less than 3% wt. of the overall process mass balance for the unit. We also contemplate a second draw (not shown) may be included to withdraw a “distillate” product, preferably a middle to heavy diesel. The liquid by-product hydrocarbons should be less than 15% wt., preferably less than 5% wt. and more preferably less than 3% wt. of the overall process mass balance.

The Product HMFO (24) resulting from the process is discharged via fluid communication into storage tanks beyond the battery limits of the immediate process. The Product HMFO complies with ISO 8217:2017 Table 2 as a residual marine fuel and has a maximum sulfur content (ISO 14596 or ISO 8754) of 0.5 Wt % and preferably a sulfur content between the range of 0.05 mass % to 0.5 mass % and more preferably a sulfur content (ISO 14596 or ISO 8754) between the range of 0.1 mass % and 0.5 mass %. The vanadium content of the Product HMFO is also compliant with ISO 8217:2017 Table 2 as a residual marine fuel with a maximum vanadium content (ISO 14597) between the range from 350 mg/kg to 450 ppm mg/kg, preferably a vanadium content (ISO 14597) between the range of 200 mg/kg and 300 mg/kg and more preferably a vanadium content (ISO 14597) between the range of 50 mg/kg and 100 mg/kg.

The Product HFMO should have properties that are compliant with ISO 8217:2017 Table 2 as a residual marine fuel including those for the Environmental Contaminants. The Product HMFO should exhibit bulk properties of: a maximum of kinematic viscosity at 50° C. (ISO 3104) between the range from 180 mm²/s to 700 mm²/s; a maximum of density at 15° C. (ISO 3675) between the range of 991.0 kg/m³ to 1010.0 kg/m³; a CCAI value in the range of 780 to 870; a flash point (ISO 2719) no lower than 60.0° C.; a total sediment—aged (ISO 10307-2) of less than 0.10 mass %; a carbon residue—micro method (ISO 10370) lower than 20 mass %, and also preferably an aluminum plus silicon (ISO 10478) content of less than 60 mg/kg.

Relative the Feedstock HMFO, the Product HMFO will have a sulfur content (ISO 14596 or ISO 8754) between 1% and 20% of the maximum sulfur content of the Feedstock HMFO. That is the sulfur content of the Product will be reduced by about 80% or greater when compared to the Feedstock HMFO. Similarly, the vanadium content (ISO 14597) of the Product HMFO is between 1% and 20% of the maximum vanadium content of the Feedstock HMFO. One of skill in the art will appreciate that the above data indicates a substantial reduction in sulfur and vanadium (as a proxy for all metals) content indicate a process having achieved a substantial reduction in the Environmental Contaminants from the Feedstock HMFO while maintaining the desirable properties of an ISO 8217:2017 Table 2 compliant HMFO.

As a side note, the residual gaseous component is a mixture of gases selected from the group consisting of: nitrogen, hydrogen, carbon dioxide, hydrogen sulfide, gaseous water, C₁-C₅ hydrocarbons. An amine scrubber will effectively remove the hydrogen sulfide content which can then be processed using technologies and processes well known to one of skill in the art. In one preferable illustrative embodiment, the hydrogen sulfide is converted into elemental sulfur using the well-known Claus process. An alternative embodiment utilizes a proprietary process for conversion of the Hydrogen sulfide to hydrosulfuric acid. Either way, the sulfur is removed from entering the environment prior to combusting the HMFO in a ships engine. The cleaned gas can be vented, flared or more preferably recycled back for use as Activating Gas.

The by-product hydrocarbon components are a mixture of hydrocarbons (wild naphtha) (naphtha—diesel) having a boiling point below 150° F. which can be directed to the motor fuel blending pool or sold over the fence to an adjoining refinery or even utilized to fire the heaters and combustion turbines to provide heat and power to the process. These by product hydrocarbons which are the result of hydrocracking reactions should be less than 10% wt., preferably less than 5% wt. and more preferably less than 2% wt. of the overall process mass balance.

Product HMFO The Product HFMO resulting from the disclosed illustrative processes is of merchantable quality for sale and use as a heavy marine fuel oil (also known as a residual marine fuel or heavy bunker fuel), that is a fuel that is stable and compatible with other marine fuels, specifically heavy (residual) marine fuels. The Product HMFO exhibits the physical properties required for the Product HMFO to be an ISO compliant (i.e. ISO8217: 2017) Table 2 residual marine fuel. In one embodiment, the Product HMFO should exhibit the bulk properties of: a maximum of kinematic viscosity at 50° C. (ISO 3104) between the range from 180 mm²/s to 700 mm²/s; a density at 15° C. (ISO 3675) between the range of 991.0 kg/m³ to 1010.0 kg/m³; a CCAI is in the range of 780 to 870; a flash point (ISO 2719) no lower than 60° C.; a total sediment-aged (ISO 10307-2) less than 0.10% wt.; and a carbon residue-micro method (ISO 10370) less than 20% wt.; and also preferably an aluminum plus silicon (ISO 10478) content no more than of 60 mg/kg.

The Product HMFO has a sulfur content (ISO 14596 or ISO 8754) less than 0.5 wt % and preferably less than 0.1% wt. and complies with the IMO Annex VI (revised) requirements for a low sulfur and preferably an ultra-low sulfur HMFO. That is the sulfur content of the Product HMFO has been reduced by about 80% or greater when compared to the Feedstock HMFO. Similarly, the vanadium content (ISO 14597) of the Product Heavy Marine Fuel Oil is less than 20% and more preferably less than 10% of the maximum vanadium content of the Feedstock Heavy Marine Fuel Oil. One of skill in the art will appreciate that a substantial reduction in sulfur and vanadium content of the Feedstock HMFO indicates a process having achieved a substantial reduction in the Environmental Contaminants from the Feedstock HMFO; of equal importance is this has been achieved while maintaining the desirable properties of an ISO 8217:2017 compliant HMFO.

The Product HMFO not only complies with ISO 8217:2017 Table 2 as a residual marine fuel (and is merchantable as a residual marine fuel oil or bunker fuel), the Product HMFO has a maximum sulfur content (ISO 14596 or ISO 8754) less than 0.5% wt. preferably a sulfur content (ISO 14596 or ISO 8754) between the range of 0.05% wt. ppm and 0.5% wt. and more preferably a sulfur content (ISO 14596 or ISO 8754) between the range of 0.1% wt. and 0.5% wt. The vanadium content of the Product HMFO is well within the maximum vanadium content (ISO 14597) required for an ISO8217: 2017 Table 2 residual marine fuel exhibiting a vanadium content lower than 450 ppm mg/kg, preferably a vanadium content (ISO 14597) lower than 300 mg/kg and more preferably a vanadium content (ISO 14597) between the range of 50 mg/kg and 100 mg/kg.

One knowledgeable in the art of marine fuel blending, bunker fuel formulations and the fuel requirements for marine shipping fuels will readily appreciate that without further compositional changes or blending, the Product HMFO can be sold and used as a low sulfur MARPOL Annex VI compliant heavy (residual) marine fuel oil that is a direct substitute for the high sulfur heavy (residual) marine fuel oil or heavy bunker fuel currently in use. One illustrative embodiment is an ISO 8217:2017 Table 2 compliant low sulfur heavy marine fuel oil comprising (and preferably consisting essentially of) hydroprocessed residual marine fuel compliant with ISO 8217:2017, Table 2 as a high sulfur heavy marine fuel oil, wherein the sulfur levels of the ISO 8217:2017 compliant high sulfur heavy marine fuel oil prior to being subjected to hydroprocessing is greater than 0.5% wt., and wherein the sulfur levels of the ISO 8217:2017 Table 2 compliant low sulfur heavy marine fuel oil (i.e/the Product HMFO) is less than 0.5% wt. Another illustrative embodiment is an ISO8217: 2017 compliant ultra-low sulfur heavy marine fuel oil comprising (and preferably consisting essentially of) a hydroprocessed ISO8217: 2017 Table 2 compliant high sulfur heavy marine fuel oil, wherein the sulfur levels of the ISO8217: 2017 Table 2 compliant high sulfur heavy marine fuel oil is greater than 0.5% wt. and wherein the sulfur levels of the ISO8217: 2017 Table 2 compliant low sulfur heavy marine fuel oil (i.e. the Product HMFO) is less than 0.1% wt.

Because of the present invention, multiple economic and logistical benefits to the bunkering and marine shipping industries can be realized. The benefits include minimal changes to the existing heavy marine fuel bunkering infrastructure (storage and transferring systems); minimal changes to shipboard systems are needed to comply with emissions requirements of MARPOL Annex VI (revised); no additional training or certifications for crew members will be needed, amongst the realizable benefits. Refiners will also realize multiple economic and logistical benefits, including: no need to alter or rebalance the refinery operations, crude slate, and product streams to meet a new market demand for low sulfur or ultralow sulfur HMFO; no additional units are needed in the refinery with additional hydrogen or sulfur capacity because the illustrative process can be conducted as a stand-alone unit; refinery operations can remain focused on those products that create the greatest value from the crude oil received (i.e. production of petrochemicals, gasoline and distillate (diesel); refiners can continue using the existing slates of crude oils without having to switch to sweeter or lighter crudes to meet the environmental requirements for HMFO products.

Heavy Marine Fuel Composition One aspect of the present inventive concept is a fuel composition comprising, but preferably consisting essentially of, the Product HMFO resulting from the processes disclosed, and may optionally include Diluent Materials. The Product HMFO complies with ISO 8217:2017 Table 2 as a residual marine fuel and meets the global IMO Annex VI requirements for maximum sulfur content (ISO 14596 or ISO 8754). If ultra-low levels of sulfur are desired, the process of the present invention achieves this without the need for blending, but one of skill in the art of marine fuel blending will appreciate that a low sulfur or ultra-low sulfur Product HMFO can be utilized as a primary blending stock to form a global IMO Annex VI compliant low sulfur Heavy Marine Fuel Composition having a sulfur content less than 0.5 wt %. Such a low sulfur Heavy Marine Fuel Composition will comprise (and preferably consist essentially of): a) the Product HMFO and b) Diluent Materials. In one embodiment, the majority of the volume of the Heavy Marine Fuel Composition is the Product HMFO with the balance of materials being Diluent Materials. Preferably, the Heavy Maine Fuel Composition is at least 75% by volume, preferably at least 80% by volume, more preferably at least 90% by volume, and furthermore preferably at least 95% by volume Product HMFO with the balance being Diluent Materials.

Diluent Materials may be hydrocarbon or non-hydrocarbon based materials mixed into or combined with or added to, or solid particle materials suspended in, the Product HMFO. The Diluent Materials may intentionally or unintentionally alter the composition of the Product HMFO but not so the resulting mixture violates the ISO 8217:2017 Table 2 standards for residual marine fuel or fails to have a sulfur content lower than the global MARPOL standard of 0.5% wt. sulfur (ISO 14596 or ISO 8754). Examples of Diluent Materials considered hydrocarbon based materials include: Feedstock HMFO (i.e. high sulfur HMFO); distillate based fuels such as road diesel, gas oil, MGO or MDO; cutter oil (which is used in formulating residual marine fuel oils); renewable oils and fuels such as biodiesel, methanol, ethanol, and the like; synthetic hydrocarbons and oils based on gas to liquids technology such as Fischer-Tropsch derived oils, synthetic oils such as those based on polyethylene, polypropylene, dimer, trimer and poly butylene; refinery residues or other hydrocarbon oils such as atmospheric residue, vacuum residue, fluid catalytic cracker (FCC) slurry oil, FCC cycle oil, pyrolysis gasoil, cracked light gas oil (CLGO), cracked heavy gas oil (CHGO), light cycle oil (LCO), heavy cycle oil (HCO), thermally cracked residue, coker heavy distillate, bitumen, de-asphalted heavy oil, visbreaker residue, slop oils, asphaltinic oils; used or recycled motor oils; lube oil aromatic extracts and crude oils such as heavy crude oil, distressed crude oils and similar materials that might otherwise be sent to a hydrocracker or diverted into the blending pool for a prior art high sulfur heavy (residual) marine fuel oil. Examples of Diluent Materials considered non-hydrocarbon based materials include: residual water (i.e. water absorbed from the humidity in the air or water that is miscible or solubilized, sometimes as microemulsions, into the hydrocarbons of the Product HMFO), fuel additives which can include, but are not limited to detergents, viscosity modifiers, pour point depressants, lubricity modifiers, de-hazers (e.g. alkoxylated phenol formaldehyde polymers), antifoaming agents (e.g. polyether modified polysiloxanes); ignition improvers; anti rust agents (e.g. succinic acid ester derivatives); corrosion inhibitors; anti-wear additives, anti-oxidants (e.g. phenolic compounds and derivatives), coating agents and surface modifiers, metal deactivators, static dissipating agents, ionic and nonionic surfactants, stabilizers, cosmetic colorants and odorants and mixtures of these. A third group of Diluent Materials may include suspended solids or fine particulate materials that are present because of the handling, storage and transport of the Product HMFO or the Heavy Marine Fuel Composition, including but not limited to: carbon or hydrocarbon solids (e.g. coke, graphitic solids, or micro-agglomerated asphaltenes), iron rust and other oxidative corrosion solids, fine bulk metal particles, paint or surface coating particles, plastic or polymeric or elastomer or rubber particles (e.g. resulting from the degradation of gaskets, valve parts, etc.), catalyst fines, ceramic or mineral particles, sand, clay, and other earthen particles, bacteria and other biologically generated solids, and mixtures of these that may be present as suspended particles, but otherwise don't detract from the merchantable quality of the Heavy Marine Fuel Composition as an ISO 8217:2017 Table 2 compliant heavy (residual) marine fuel.

The Heavy Marine Fuel Composition must be of merchantable quality as a low sulfur residual marine fuel. That is the blend must be suitable for the intended use as heavy marine bunker fuel and generally be fungible, (i.e. blendable and compatible) with other residual marine fuels used as a bunker fuel for ocean going ships. Preferably the Heavy Marine Fuel Composition must retain the physical properties required of an ISO 8217:2017 Table 2 compliant residual marine fuel oil and a sulfur content lower than the global MARPOL standard of 0.5% wt. sulfur (ISO 14596 or ISO 8754) so that the material qualifies as MARPOL Annex VI Low Sulfur Heavy Marine Fuel Oil (LS-HMFO). The sulfur content of the Product HMFO can be much lower than 0.5% wt. (i.e. below 0.1% wt sulfur (ISO 14596 or ISO 8754)) to qualify as a MARPOL Annex VI compliant Ultra-Low Sulfur Heavy Marine Fuel Oil (ULS-HMFO) and a Heavy Marine Fuel Composition likewise can be formulated to qualify as a MARPOL Annex VI compliant ULS-HMFO suitable for use as marine bunker fuel in the ECA zones. To qualify as an ISO 8217:2017Table 2 residual marine fuel, the Heavy Marine Fuel Composition of the present invention must meet those internationally accepted standards. The properties of the Heavy Marine Fuel Composition should include: a maximum of kinematic viscosity at 50° C. (ISO 3104) between the range from 180 mm²/s to 700 mm²/s; a density at 15° C. (ISO 3675) between the range of 991.0 kg/m³ to 1010.0 kg/m³; a CCAI is in the range of 780 to 870; a flash point (ISO 2719) no lower than 60° C.; a total sediment—aged (ISO 10307-2) less than 0.10% wt.; and a carbon residue—micro method (ISO 10370) less than 20% wt., and an aluminum plus silicon (ISO 10478) content no more than of 60 mg/kg.

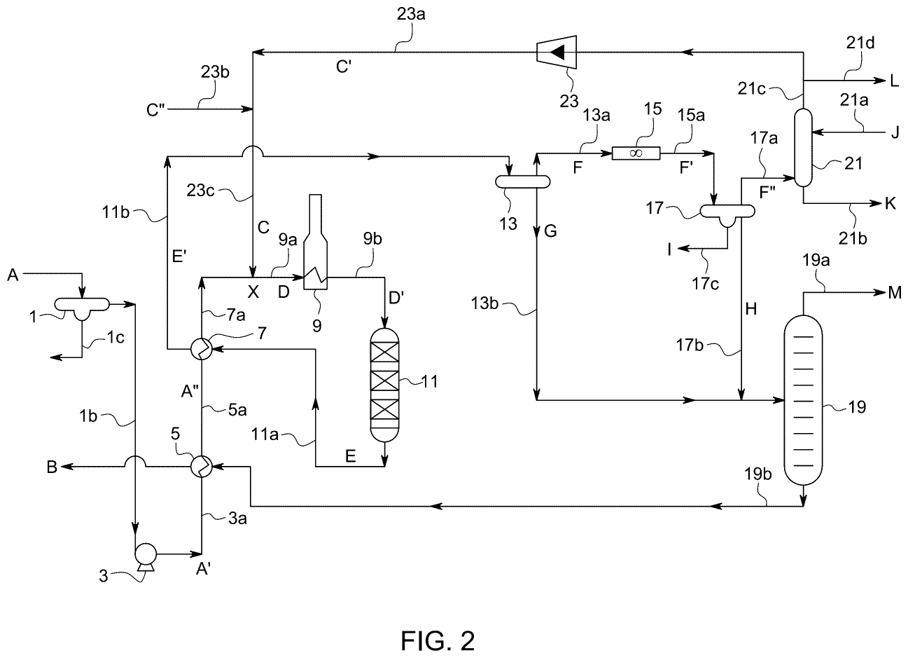

Production Plant Description Production Plant Description: Turning now to a more detailed illustrative embodiment of a production plant, FIG. 2 shows a schematic for a production plant implementing the process described above for reducing the Environmental Contaminants in a Feedstock HMFO to produce a Product HMFO according to the second illustrative embodiment. One of skill in the art will appreciate that FIG. 2 is a generalized schematic drawing, and the exact layout and configuration of a plant will depend upon factors such as location, production capacity, environmental conditions (i.e. wind load, etc.) and other factors and elements that a skilled detailed engineering firm can provide. It will be appreciated by one of skill in the art that additional alternative embodiments for the core process and the pretreatment or posttreatment processes disclosed above may involve multiple vessels and reactors even though only one of each is shown. Such variations are contemplated and within the scope of the present disclosure.

In FIG. 2, Feedstock HMFO (A) is fed from outside the battery limits (OSBL) to the Oil Feed Surge Drum (1) that receives feed from outside the battery limits (OSBL) and provides surge volume adequate to ensure smooth operation of the unit. Water entrained in the feed and bulk solids (sand, rust particles, etc.) are removed from the HMFO with the water and bulk solids being discharged a stream (1c) for treatment OSBL.

The Feedstock HMFO (A) is withdrawn from the Oil Feed Surge Drum (1) via line (1b) by the Oil Feed Pump (3) and is pressurized to a pressure required for the process. The pressurized HMFO (A′) then passes through line (3a) to the Oil Feed/Product Heat Exchanger (5) where the pressurized HMFO Feed (A′) is partially heated by the Product HMFO (B). The pressurized Feedstock HMFO (A′) passing through line (5a) is further heated against the effluent from the Reactor System (E) in the Reactor Feed/Effluent Heat Exchanger (7).

The heated and pressurized Feedstock HMFO (A″) in line (7a) is then mixed with Activating Gas (C) provided via line (23c) at Mixing Point (X) to form a Feedstock Mixture (D). The mixing point (X) can be any well know gas/liquid mixing system or entrainment mechanism well known to one skilled in the art.

The Feedstock Mixture (D) passes through line (9a) to the Reactor Feed Furnace (9) where the Feedstock Mixture (D) is heated to the specified process temperature. The Reactor Feed Furnace (9) may be a fired heater furnace or any other kind to type of heater as known to one of skill in the art if it will raise the temperature of the Feedstock Mixture (D) to the desired temperature for the process conditions.

Although not shown, it is contemplated that the above-described mixing and heating steps can be interchanged such that the Feedstock HMFO is first heated and then mixed with the Activating Gas. In such an embodiment, that mixing may take place immediately prior to, concurrently with or immediately after injection of the hydrocarbon feed into the Reactor System.

Returning to the Figure, the fully Heated Feedstock Mixture (D′) exits the Reactor Feed Furnace (9) via line 9b and is fed into the Reactor System (11). The fully heated Feedstock Mixture (D′) enters the Reactor System (11) where environmental contaminates, such a sulfur, nitrogen, and metals are preferentially removed from the Feedstock HMFO component of the fully heated Feedstock Mixture. The Reactor System contains catalyst materials some or all of which many be within a structured catalyst bed, and which preferentially removes the Environmental Contaminates, principally organometal and organosulfur compounds in the Feedstock HMFO component by reacting them with hydrogen in the Activating Gas to form deposits of metals, metal sulfides and/or hydrogen sulfide. In addition to the hydrodesulfurization, the Reactor System will also achieve demetallization, denitrogenation, and a certain amount of ring opening hydrogenation of the complex aromatics and asphaltenes, however a minimal amount of hydrocracking of hydrocarbons should take place. The process conditions of hydrogen partial pressure, reaction pressure, temperature and residence time as measured by liquid hourly velocity are optimized to achieve desired final product quality. A more detailed discussion of the Reactor System, the structured catalyst beds, the catalyst, the process conditions, and other aspects of the process are contained below in the “Reactor System Description.” Variations using multiple vessels/reactors are contemplated by the present invention but are not illustrated in greater detail for simplicity's sake.

In this embodiment, the Reactor System Effluent (E) exits the Reactor System (11) via line (11a) and exchanges heat against the pressurized and partially heats the Feedstock HMFO (A′) in the Reactor Feed/Effluent Exchanger (7). The partially cooled Reactor System Effluent (E′) then flows via line (11c) to the Hot Separator (13).

The Hot Separator (13) separates the gaseous components of the Reactor System Effluent (F) which are directed to line (13a) from the liquid components of the Reactor System effluent (G) which are directed to line (13b). The gaseous components of the Reactor System effluent in line (13a) are cooled against air in the Hot Separator Vapor Air Cooler (15) and then flow via line (15a) to the Cold Separator (17).

The Cold Separator (17) further separates any remaining gaseous components from the liquid components in the cooled gaseous components of the Reactor System Effluent (F′). The gaseous components from the Cold Separator (F″) are directed to line (17a) and fed onto the Amine Absorber (21). The Cold Separator (17) also separates any remaining Cold Separator hydrocarbon liquids (H) in line (17b) from any Cold Separator condensed liquid water (I). The Cold Separator condensed liquid water (I) is sent OSBL via line (17c) for

The hydrocarbon liquid components of the Reactor System effluent from the Hot Separator (G) in line (13b) and the Cold Separator hydrocarbon liquids (H) in line (17b) are combined and are fed to the Oil Product Stripper System (19). The Oil Product Stripper System (19) removes any residual hydrogen and hydrogen sulfide as well as separating the by-product hydrocarbons (i.e. hydrocarbons having a boiling point less than 150F) from the Product HMFO (B) which is discharged in line (19b) to storage OSBL. It is also contemplated that a second draw (not shown) may be included to withdraw a distillate product, preferably a middle to heavy distillate, this may be done to control the viscosity and density (and thus the CCAI) of the Product HMFO. The vent stream (M) from the Oil Product Stripper in line (19a) may be sent to the fuel gas system or to the flare system that are OSBL. A further discussion of the Oil Product Stripper System is contained in the “Oil Product Stripper System Description.”

The gaseous components from the Cold Separator (F″) in line (17a) contain a mixture of hydrogen, hydrogen sulfide and light hydrocarbons (mostly methane and ethane). This vapor stream (17a) feeds an Amine Absorber System (21) where it is contacted against Lean Amine (J) provided OSBL via line (21a) to the Amine Absorber System (21) to remove hydrogen sulfide from the gases making up the Activating Gas recycle stream (C′). Rich amine (K) which has absorbed hydrogen sulfide exits the bottom of the Amine Absorber System (21) and is sent OSBL via line (21b) for amine regeneration and sulfur recovery.

The Amine Absorber System overhead vapor in line (21c) is preferably recycled to the process as a Recycle Activating Gas (C′) via the Recycle Compressor (23) and line (23 a) where it is mixed with the Makeup Activating Gas (C″) provided OSBL by line (23b). This mixture of Recycle Activating Gas (C′) and Makeup Activating Gas (C″) to form the Activating Gas (C) utilized in the process via line (23c) as noted above. A Scrubbed Purge Gas stream (H) is taken from the Amine Absorber System overhead vapor line (21c) and sent via line (21d) to OSBL to prevent the buildup of light hydrocarbons or other non-condensable hydrocarbons. A more detailed discussion of the Amine Absorber System is contained in the “Amine Absorber System Description.”

Reactor System Description: The core process Reactor System (11) illustrated in FIG. 2 comprises a single reactor vessel loaded with the process catalyst and sufficient controls, valves and sensors as one of skill in the art would readily appreciate. Variations using multiple vessels/reactors are contemplated by the present invention but are not illustrated in greater detail for simplicity's sake. One of skill in the art will appreciate that the reactor vessel itself must be engineered to withstand the pressures, temperatures and other conditions (i.e. presence of hydrogen and hydrogen sulfide) of the process. Using special alloys of stainless steel and other materials typical of such a unit are within the skill of one in the art and well known. As illustrated, one or more beds in the reactor vessel may be a structured catalyst bed or a fixed dense packed catalyst bed or combinations of these. A Reactor System containing at least one reactor vessel with at least one structured catalyst bed is preferred as these are easier to operate and maintain, however other reactor types are also within the scope of the invention and a Reactor System having multiple reaction vessels one or more of which may be under reactive distillation conditions is contemplated.

A description of the process catalyst, the selection of the process catalyst and the grading of the catalyst within the reactor vessel is contained in the “Catalyst in Reactor System”.

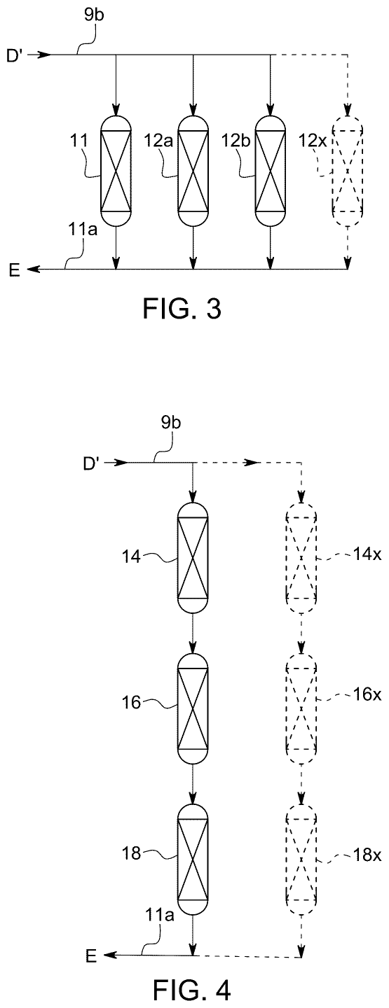

Alternative configurations for the core process Reactor System (11) are contemplated. In one illustrative configuration, more than one reactor vessel may be utilized in parallel as shown in FIG. 3 to replace the core process Reactor System (11) illustrated in FIG. 2.

In the embodiment in FIG. 3, each reactor vessel is loaded with process catalyst in a similar manner and each reactor vessel in the Reactor System is provided the heated Feed Mixture (D′) via a common line 9b. The effluent from each reactor vessel in the Reactor System is recombined and forms a combined Reactor Effluent (E) for further processing as described above via line 1la. The illustrated arrangement will allow the three reactors to carry out the process effectively multiplying the hydraulic capacity of the overall Reactor System. Control valves and isolation valves may also prevent feed from entering one reactor vessel but not another reactor vessel. In this way one reactor can be by-passed and placed off-line for maintenance and reloading of catalyst while the remaining reactors continue to receive heated Feedstock Mixture (D′). It will be appreciated by one of skill in the art this arrangement of reactor vessels in parallel is not limited in number to three, but multiple additional reactor vessels can be added as shown by dashed line reactor. The only limitation to the number of parallel reactor vessels is plot spacing and the ability to provide heated Feedstock Mixture (D′) to each active reactor.

A cascading series in FIG. 4 can also be substituted for the single reactor vessel Reactor System 11 in FIG. 2. The cascading reactor vessels are loaded with process catalyst with the same or different activities toward metals, sulfur or other Environmental Contaminants to be removed. For example, one reactor may be loaded with a highly active demetallization catalyst, a second subsequent or downstream reactor may be loaded with a balanced demetallization/desulfurizing catalyst, and reactor downstream from the second reactor may be loaded with a highly active desulfurization catalyst. This allows for greater control and balance in process conditions (temperature, pressure, space flow velocity, etc.) so it is tailored for each catalyst. In this way one can optimize the parameters in each reactor depending upon the material being fed to that specific reactor/catalyst combination and minimize the hydrocracking reactions.

Another illustrative embodiment of the replacement of the single reactor vessel Reactor System 11 in FIG. 2 is a matrix of reactors composed of interconnected reactors in parallel and in series. A simple 2×2 matrix arrangement of reactors with associated control valves and piping illustrates this embodiment, however a wide variety of matrix configurations such as 2×3; 3×3, etc. . . . are contemplated and within the scope of the present invention. A 2 reactor by 2 reactor (2×2) matrix of comprises four reactor vessels each with reactor inlet control valves and reactor outlet control valves associated with each vessel. Horizontal flow control valves regulate the flow across the matrix from heated Feedstock (D′) in line 9b to discharging Reactor Effluent (E) into line 11a. Vertical flow control valves control the flow through the matrix from line 9b to line 11a. One of skill in the art will appreciate that control over the multiple valves and flow can be achieved using a computerized control system/distributed control system (DCS) or programable logic controllers (PLC) programed to work with automatic motorized valve controls, position sensors, flow meters, thermocouples, etc. These systems are commercially available from vendors such as Honeywell International, Schneider Electric; and ABB. Such control systems will include lock-outs and other process safety control systems to prevent opening of valves in manner either not productive or unsafe.

One of skill in the art will quickly realize and appreciate that by opening and closing the valves and varying the catalyst loads present in each reactor, many configurations may be achieved. One such configuration would be to open valves and close other valves so the flow for heated Feed Mixture (D′) will pass through the reactors in series. Another such configuration would be to open valves and close other valves so the flow of heated Feed Mixture (D′) will pass through three of the reactors in series, but not the fourth. As with the prior example, the nature of the Feedstock HSFO and the catalyst loaded in each reactor and the presence or absence of structured catalyst beds may be optimized and adjusted to achieve the desired Product HSFO properties, however for brevity of disclose all such variations will be apparent to one of skill in the art.

One benefit of having a multi-reactor Reactor System is that it allows for a reactor that is experiencing decreased activity or plugging because of coke formation to be isolated and taken off line for turn-around (i.e. deactivated, catalyst and internals replaced, etc.) without the entire plant having to shut down. Another benefit as noted above is that it allows one to vary the catalyst loading in the Reactor System so the overall process can be optimized for a specific Feedstock HSFO. A further benefit is that one can design the piping, pumps, heaters/heat exchangers, etc. to have excess capacity so that when an increase in capacity is desired, additional reactors can be quickly brought on-line. Conversely, it allows an operator to take capacity off line, or turn down a plant output without having a concern about turn down and minimum flow through a reactor. While the above matrix Reactor System is described referring to a fixed bed or packed bed trickle flow reactor, one of skill in the art will appreciate that other reactor types may be utilized. For example, one or more reactors may be configured to be ebullated bed up flow reactors or three phase upflow bubble reactors, or counter-current reactors, or reactive distillation reactors the configuration of which will be known to one of skill in the art. It is anticipated that many other operational and logistical benefits will be realized by one of skill in the art from the Reactor Systems configurations disclosed.

Structured Catalyst Bed Turning now to the structured catalyst bed, similar beds have been disclosed in the prior art in relation to many catalyst promoted reactions. See for example U.S. Pat. Nos. 4,731,229; 5,073,236; 5,266,546; 5,431,890; 5,730,843; USUS2002068026; US20020038066; US20020068026; US20030012711; US20060065578; US20070209966; US20090188837; US2010063334; US2010228063; US20110214979; US20120048778; US20150166908; US20150275105; 20160074824; 20170101592 and US20170226433, the contents of which are incorporated herein by reference. While some disclosures involved reactive distillations conditions, one of skill in the art will note these disclosures involve the product being distilled from heavier bottoms or feedstock materials. For example heavy and light naphtha streams are desulfurized with the desired light naphtha being the desired product for the gasoline pool and the heavy naphtha either recycled or sent to an FCC unit for further upgrading. The process of the invention utilizes the reactive distillation process to remove undesired by-product hydrocarbons and gases produced by the catalytic reaction (i.e. ammonia and hydrogen sulfide) and the desired residual product is the bottoms stream that is catalytically treated, but not distilled. These aspects of the inventive concepts are disclosed in greater detail in the description of the Reactive Distillation Reactor below.

The structured catalyst beds as described above are designed to balance the catalyst density load, the catalyst activity load and the desired liquid space velocity through the reactor so an effective separation or distillation of purified lighter products can be produced. In contrast the present process functionally combines the functioning of a reactor with a stripper column or knock down drum. A further problem solved by the structured catalyst bed is to reduce the pressure drop through the catalyst beds and provision of sufficient contact of the Feedstock Mixture with the catalyst and mixing with the Activating Gas.

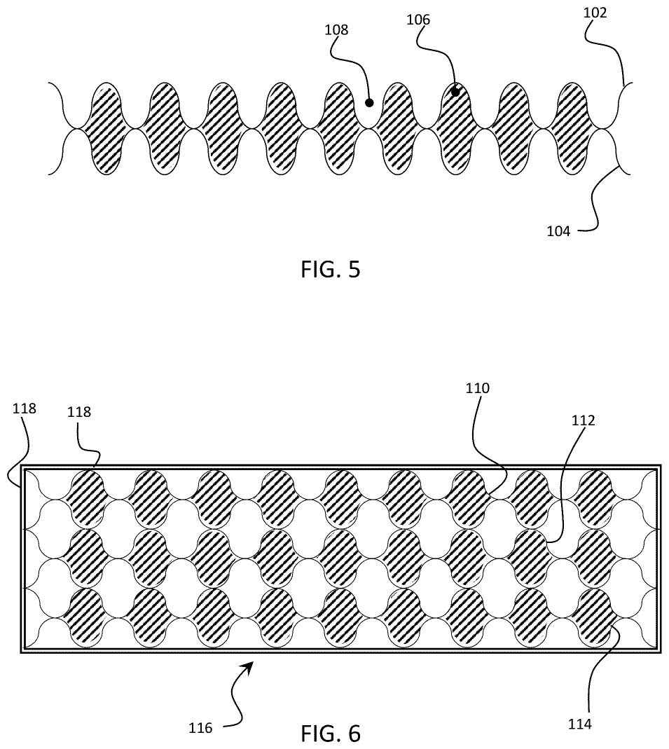

A first illustrative embodiment of the structured catalyst beds is shown in FIG. 5 and FIG. 6 in a side view. As illustrated in FIG. 5 is a catalyst retention composed of a pair of fluid permeable corrugated metal sheets (102 and 104), wherein the pair of the fluid permeable corrugated metal sheets are aligned so the corrugations are sinusoidal, have the same wave length and amplitude, but are out of phase and defining a catalyst rich space (106) and a catalyst lean space (108). The catalyst rich space will be loaded with one or more catalyst materials and optionally inert packing materials. The catalyst lean space (108) may be left empty or it may be loaded with inert packing such as ceramic beads, inactive (non-metal containing) catalyst support, glass beads, rings, wire or plastic balls and the like. These inert packing materials may serve the role of assisting in the mixing of the Activating Gas with the Feedstock HMFO, facilitate the removal or separation of gaseous by products (i.e. hydrogen sulfide or ammonia) from the process mixture or facilitate the separation of any hydrocarbon by-products.

FIG. 6 shows a side perspective a plurality of catalyst retention structures (110, 112 and 114) formed into a structured catalyst bed (116). Structural supports (118) may be optionally incorporated into the structured catalyst bed to lend rigidity as needed. As shown the catalyst rich spaces are radially aligned so the catalyst rich spaces of one catalyst retention structure is aligned with the catalyst rich structure of the adjacent layers. In the illustrated configuration, the radial angle between adjacent layers is 0° (or 180°). One of skill in the art will appreciate that the angle of radial alignment between adjacent layers may be varied from 0° to 180°, preferably between 20° and 160° and more preferably 90° so the catalyst rich areas in one layer are perpendicular to the adjacent layers. It will be further appreciated that the alignment of a particular set of three or more layers need not be the same. A first layer may be aligned along and define the 0° axis relative to the other two layers; a second adjacent layer may be radially aligned along a 45° angle relative to the first layer; and the third layer aligned along a 90° angle relative to the first layer. This pattern of alignment may be continued until the desired number of layers is achieved. It also should be appreciated that it may be desirable to angle of the catalyst rich spaces (ie. the plane of the catalyst retention structure), relative to the flow of Feedstock HMFO and Activating Gas within the reaction vessel. This relative angle is referred to herein as the inclination angle. As shown in FIG. 6, the inclination angel is perpendicular (90°) to the flow of Feedstock HMFO and Activating Gas through the reactor vessel. However, it will be appreciated that the inclination level may be varied between 0°, in which case the catalyst rich spaces are vertically aligned with the side walls of the reactor vessel and 90° in which case the catalyst rich spaces are perpendicular to the side walls of the reactor vessel. By varying both the radial alignment and the inclination angle of the catalyst rich spaces, one can achieve a wide variety and be able to optimize the flow of Feedstock HMFO though the reactor vessel with minimal plugging/coking.

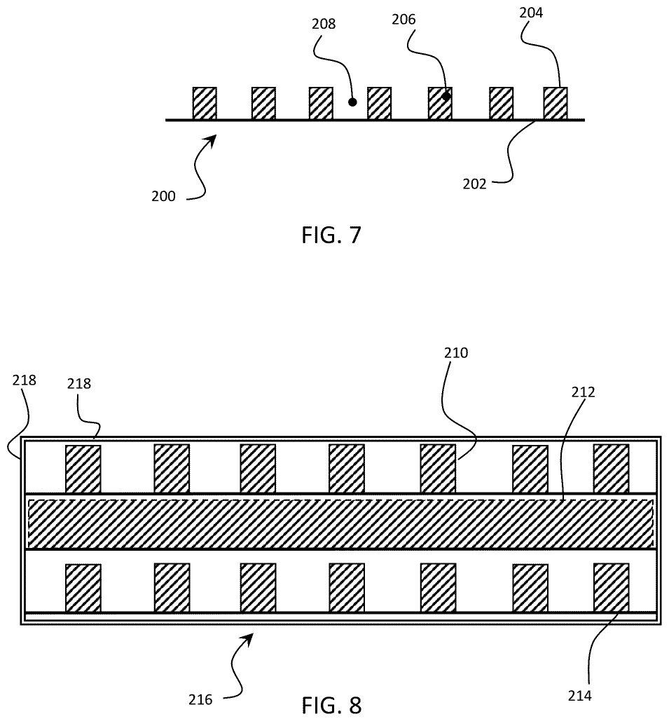

A second illustrative embodiment of the structured catalyst beds is shown in FIG. 7 and FIG. 8 in a side view. As illustrated in FIG. 7, catalyst retention structure (200) comprises a flat fluid permeable metal sheet (202) and a corrugated fluid permeable metal sheet (204) aligned to be co-planar and defining a catalyst rich space (206) and a catalyst lean space (208). As with the prior illustrative embodiment, the catalyst rich space will contain one or more catalyst materials and optionally inert packing materials and the catalyst lean space will be empty or optionally contain inert packing materials. FIG. 8 shows a side perspective of a plurality of catalyst retention structures (210, 212 and 214) formed into a structured catalyst bed (216). Structural supports (218) may be optionally incorporated into the structured catalyst bed to lend rigidity as needed. As shown the catalyst rich spaces are radially aligned so the catalyst rich spaces of one catalyst retention structure is perpendicular with the catalyst rich structure of the adjacent layers. In the illustrated configuration, the radial angle between adjacent layers is 90°. The same considerations of radial alignment and inclination of the catalyst retention structures described above will apply to this embodiment. The principle benefit of the illustrated structured catalyst bed is that the manufacturing process because affixing the flat fluid permeable sheet and the corrugated fluid permeable sheet will be greatly simplified. Further as illustrated, if the corrugated sheet is constructed using 90° angle corrugations, each catalyst retention structure can withstand much greater weight loadings than if the corrugations are sinusoidal.

The loading of the catalyst structures will depend upon the particle size of the catalyst materials and the activity level of the catalyst. The structures should be loaded so the open space will be at least 10 volume % of the overall structural volume, and preferably will be up to about 65% of the overall structural volume. Active catalyst materials should be loaded in the catalyst support structure at a level dependent upon the catalyst activity level and the desired level of treatment. For example a catalyst material highly active for desulfurization may be loaded at a lower density than a less active desulfurization catalyst material and yet still achieve the same overall balance of catalyst activity per volume. One of skill in the art will appreciate that by systematically varying the catalyst loaded per volume and the catalyst activity level one may optimize the activity level and fluid permeability levels of the structured catalyst bed. In one such example, the catalyst density is such that over 50% of the open space in the catalyst rich space, which may occupy only have of the over space within the structured catalyst bed. In another example catalyst rich space is fully loaded (i.e. dense packed into each catalyst rich space), however the catalyst rich space may occupy only 30 volume % of the overall structured catalyst bed. It will be appreciated that the catalyst density in the catalyst rich space may vary between 30 vol % and 100 vol % of the catalyst rich space. It will be further appreciated that that catalyst rich space may occupy as little as 10 vol % of the overall structured catalyst bed or it may occupy as much as 80 vol % of the overall structured catalyst bed.

The liquid hourly space velocity within the structured catalyst beds should be between 0.05 oil/hour/m³ catalyst and 10.0 oil/hour/m³ catalyst; preferably between 0.08 oil/hour/m³ catalyst and 5.0 oil/hour/m³ catalyst and more preferably between 0.1 oil/hour/m³ catalyst and 3.0 oil/hour/m³ catalyst to achieve deep desulfurization using a highly active desulfurization catalyst and this will achieve a product with sulfur levels below 0.1 ppmw. However, it will be appreciated by one of skill in the art that when there is lower catalyst density, it may be desirable to adjust the space velocity to value outside of the values disclosed.

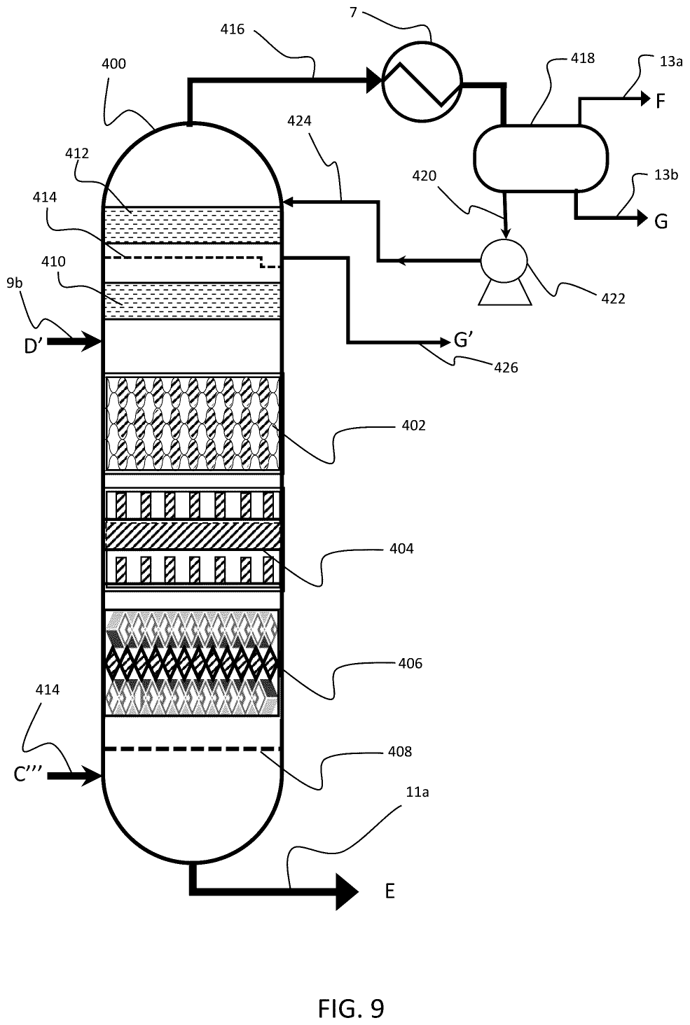

Reactive Distillation Reactor As in FIG. 9, a reactive Reactor System as contemplated by the present invention will comprise a reactor vessel (400) within which one or more structured beds are provided (402, 404 and 406). One of skill in the art will note that heated Feedstock Mixture (D′) enters the reactor vessel in the upper portion of the reactor via line (9b) above the structured catalyst beds (402, 404 and 406). When elements are the same as those previously disclosed, the same reference number is utilized for continuity within the disclosure. Entry of the heated Feedstock Mixture (D′) above the structured catalyst beds (402, 404 and 406) may be facilitated by a distribution tray or similar device not shown. It will also be noted that each of the structured catalyst beds is different in appears, the reason for this will now described. The upper most structured catalyst bed (402) will be preferably loaded with a demetallization catalyst and in a structure optimized for the demetallization of the Feedstock mixture. The middle structured catalyst bed (404) will preferably be loaded with a transition catalyst material or a mixture of demetallization and low activity desulfurization catalyst. The lower most structured catalyst bed will be preferably loaded with a desulfurization catalyst of moderate to high activity. A gas sparger or separation tray (408) is below structured catalyst tray 406. In this way, the Feedstock Mixture flows from the upper portion of the reactor to the lower portion of the reactor and will be transformed into Reaction Mixture (E) which exits the bottom of the reactor via line 11a.

As shown, make up Activating Gas C′″ will be provided via line 414 to both quench and create within the reactor a counter-current flow of Activating gas within the reactor. One of skill in the art will appreciate this flow may also be connected to the reactor so make up Activating gas is also injected between structured catalyst beds 406 and 404 and 404 and 402. In the upper portion of the reactor, inert distillation packing beds (410 and 412) may be located. It may be desirably and optionally it is preferable for the lower most upper beds (410) to be a structured catalyst bed as well with catalyst for the desulfurization of the distillate materials. In such an instance a liquid draw tray, or a downcomer tray or similar liquid diversion tray (414) is inserted so a flow of middle to heavy distillate (G′) can be removed from the upper portion of the reactor via line (426). Light hydrocarbons (i.e. lighter than middle distillate exits the top of the reactor via line (416) and passes through heat exchanger (7) to help with heat recovery. This stream is then directed to the reflux drum (418) in which liquids are collected for use as reflux materials. The reflux loop to the upper reactor is completed via reflux pump (422) and reflux line (424). That portion of the lights not utilized in the reflux are combined with similar flows (F and G) via lines 13a and 13b respectively.

One of skill in the art of reactor design will note that unlike the prior art reactive distillation processes and reactor designs, the present invention presents multiple novel and non-obvious (i.e. inventive step) features. One such aspect the Feedstock Mixture enters the upper portion of the reactor above the structured catalytic beds. In doing so it is transformed into Reaction Mixture that exits the bottom of the reactor. One of skill in the art will appreciate that by this flow, the majority of HMFO material (which is characterized as being residual in nature) will not be volatile or distilled, but any byproduct gases, distillate hydrocarbons or light hydrocarbons are volatilized into the upper portion of the reactor. The reactor will be hydraulically designed so the majority of the volume of the liquid components having residual properties in the Feedstock Mixture will exit the lower portion of the reactor, preferably over 75% vol. of the volume of the liquid components having residual properties in the Feedstock Mixture will exit the lower portion of the reactor and even more preferably over 90% vol. of the volume of the liquid components having residual properties in the Feedstock Mixture will exit the lower portion of the reactor. This is in contrast with the prior art where the majority of the desired products exit the upper portion of the reactor via distillation and the residual bottoms portions (mostly feedstock and by-product materials) are recycled or sent to another refinery unit for further processing.

In a variation of the above illustrative embodiment, one or more fixed bed reactor(s) containing, solid particle filtering media such as inactive catalyst support, inert packing materials, selective absorption materials such as sulfur absorption media, demetallization catalyst or combinations and mixtures of these may be located upstream of the Reactive distillation reactor. In one alternative embodiment a reactor with a mixture of hydrodemetallization catalyst, decarbonization catalysts and inert materials will act as a guard bed, protecting the reactive distillation reactor from high levels of metals, concarbon (CCR) and other contaminants that can reduce the run length of the reactive distillation reactor. In another embodiment, the upstream reactors are loaded within inert packing materials and deactivated catalyst to remove solids followed by a reactor loaded within hydrodemetallization catalyst. One of skill in the art will appreciate these upstream reactors may allow the upstream reactors to be taken out of service and catalysts changed out without shutting down or affecting operation of the reactive distillation reactor.

In another variation of the above illustrative embodiment in FIG. 9, a fired reboiler can be added to the lower portion of the reactive distillation reactor. Such a configuration would take a portion of the Product HMFO from the bottom of the reactor prior to its exit via line 11a, pass it through a pump and optionally a heater, and reintroduce the material into the reactor above tray 408 and preferably above the lowermost structured catalyst bed (406). The purpose of the reboiler will be to add or remove heat within the reactive distillation reactor, and will increase column traffic, because of this reboiler loop a temperature profile in the reactive distillation reactor will be controlled and more distillate product(s) (such as diesel, light gas oils wild napthas and light hydrocarbons) may be taken off the top. We assume the severity in the column could be increased to increase the hydrocracking activity within the reactive distillation reactor, increasing the distillate production (i.e. diesel and light gas oil), however this will be at the expense of the production of Product HMFO. Because of the washing effect caused by refluxing Product HMFO back into the reactive distillation reactor, coking and fouling of catalysts should be minimized, allowing for extending run lengths.

Catalyst in Reactor System: Generally a reactor vessel in each Reactor System is loaded with one or more process catalysts, preferably within one or more structured beds. The selection of the catalyst system in each reactor vessel is a function of feedstock properties, product requirements and operating constraints and optimization of the process catalyst for the specific reactor and can be carried out by routine trial and error by one of ordinary skill in the art.

Within the scope of the present invention, the process catalyst(s) (also called catalyst materials) comprise at least one metal selected from the group consisting of the metals each belonging to the groups 6, 8, 9 and 10 of the Periodic Table, and more preferably a mixed transition metal catalyst such as Ni—Mo, Co—Mo, Ni—W or Ni—Co—Mo are utilized. The metal is preferably supported on a porous inorganic oxide catalyst carrier. The porous inorganic oxide catalyst carrier is at least one carrier selected from the group consisting of alumina, alumina/boria carrier, a carrier containing metal-containing aluminosilicate, alumina/phosphorus carrier, alumina/alkaline earth metal compound carrier, alumina/titania carrier and alumina/zirconia carrier. The preferred porous inorganic oxide catalyst carrier is alumina. The pore size and metal loadings on the carrier may be systematically varied and tested with the desired feedstock and process conditions to optimize the properties of the Product HMFO. One of skill in the art knows that demetallization using a transition metal catalyst (such a CoMo or NiMo) is favored by catalysts with a relatively large surface pore diameter and desulfurization is favored by supports having a relatively small pore diameter. Generally the surface area for the catalyst material ranges from 200-300 m²/g. The systematic adjustment of pore size and surface area, and transition metal loadings activities to preferentially form a demetallization catalyst or a desulfurization catalyst are well known and routine to one of skill in the art.

The catalyst selection utilized within and for loading the Reactor System may be preferentially designed with a catalyst loading scheme that results in the Feedstock Mixture first contacting a catalyst bed that with a catalyst preferential to demetallization followed downstream by a bed of catalyst with mixed activity for demetallization and desulfurization followed downstream by a catalyst bed with high desulfurization activity. A bed of inert materials may be loaded as the first bed followed by a bed with high demetallization activity the two beds acting as a guard bed to minimize metal deposits on the subsequent the desulfurization beds.

The objective of the Reactor System is to treat the Feedstock HMFO at the severity required to meet the Product HMFO specification for sulfur and minimize the thermal and catalytic hydrocracking reacions. Demetallization, denitrogenation and hydrocarbon hydrogenation reactions may also occur to some extent when the process conditions are optimized so the performance of the Reactor System achieves the required level of desulfurization. Hydrocracking is preferably minimized to reduce the volume of hydrocarbons formed as by-product hydrocarbons to the process. In one illustrative embodiment, the process objective is to selectively remove the Environmental Contaminants from Feedstock HMFO via demetallization and desulfurization, and minimize the formation of unnecessary by-product hydrocarbons (C₁-C₈ hydrocarbons including wild naphtha having a boiling point less than 150 F).

The process conditions in each reactor vessel will depend upon the availability and properties of all feedstock materials, the catalyst utilized, the properties of the Feedstock HMFO, and the desired properties of the Product HMFO. Variations in conditions are to be expected by one of ordinary skill in the art and these may be determined by pilot plant testing and systematic optimization of the process through routine process variable changes. With this in mind it has been found that the operating pressure, the indicated operating temperature, the ratio of the Activating Gas to Feedstock HMFO, the partial pressure of hydrogen in the Activating Gas and the space velocity, and the hydraulic capacity of the reactive distillation reactors all are important parameters to consider. The operating pressure of the Reactor System should be in the range of 250 psig and 3000 psig, preferably between 1000 psig and 2500 psig and more preferably between 1500 psig and 2200 psig. The indicated operating temperature of the Reactor System should be 500° F. to 900° F., preferably between 650° F. and 850° F. and more preferably between 680° F. and 800° F. The ratio of the quantity of the Activating Gas to the quantity of Feedstock HMFO should be in the range of 250 scf gas/bbl of Feedstock HMFO to 10,000 scf gas/bbl of Feedstock HMFO, preferably between 2000 scf gas/bbl of Feedstock HMFO to 5000 scf gas/bbl of Feedstock HMFO and more preferably between 2500 scf gas/bbl of Feedstock HMFO to 4500 scf gas/bbl of Feedstock HMFO. The Activating Gas should be selected from mixtures of nitrogen, hydrogen, carbon dioxide, gaseous water, and methane, so Activating Gas has an ideal gas partial pressure of hydrogen (p_{H2}) greater than 80% of the total pressure of the Activating Gas (P) and preferably wherein the Activating Gas has an ideal gas partial pressure of hydrogen (p_{H2}) greater than 95% of the total pressure of the Activating Gas (P). The Activating Gas may have a hydrogen mole fraction in the range between 80% of the total moles of Activating Gas and more preferably wherein the Activating Gas has a hydrogen mole fraction between 80% and 99% of the total moles of Activating Gas. The liquid hourly space velocity within the Reactor System should be between 0.05 oil/hour/m³ catalyst and 1.0 oil/hour/m³ catalyst; preferably between 0.08 oil/hour/m³ catalyst and 0.5 oil/hour/m³ catalyst and more preferably between 0.1 oil/hour/m³ catalyst and 0.3 oil/hour/m³ catalyst to achieve deep desulfurization with product sulfur levels below 0.1 ppmw.

The hydraulic capacity rate of the Reactor System should be between 100 bbl of Feedstock HMFO/day and 100,000 bbl of Feedstock HMFO/day, preferably between 1000 bbl of Feedstock HMFO/day and 60,000 bbl of Feedstock HMFO/day, more preferably between 5,000 bbl of Feedstock HMFO/day and 45,000 bbl of Feedstock HMFO/day, and even more preferably between 10,000 bbl of Feedstock HMFO/day and 30,000 bbl of Feedstock HMFO/day. The desired hydraulic capacity may be achieved in a single reactor vessel Reactor System or in a multiple reactor vessel Reactor System as described.

Modular Reactor The Reactor System may be field constructed or modularized. A significant advantage of a modularized Reactor System will be the ability to change-out entire reactor vessels; as opposed to changing out or revamping the internals of a conventional fixed in place reactor. When the active reactor must be shut down for servicing (i.e. change catalyst, replace internals, etc. . . . ); the entire reactor (reactor vessel and internal components) may be changed out at rather than conventionally changing out catalyst beds and internals on-site. Changing out of the reactor vessels will dramatically decrease time plant down time by eliminating the on-site process of catalyst unloading, loading and conditioning, minimize field construction/change out activities, reduce safety risks and improve Plant operating efficiency.

A modular Reactor System as contemplated by the present invention may comprise a continuous tubular reactor vessel 102 defined by an outer wall surrounding an internal space. One or more inlet flanges 104 and one or more outlet flanges 106 flange are in fluid communication with each other via the interior to the reactor vessel. The outer wall of the reactor vessel is sized so it will be contained within a standard ISO 20 ft container (i.e. 2.43 m×2.59 m×6.06 m) or a standard ISO 40 ft container (i.e. 2.43 m×2.59 m×12.2 m) framework structure 108. The outer wall of the reactor vessel will be supported and braced within the ISO container framework in a conventional manner known to one of skill in that art, but not shown in the drawing so that the framework and reactor vessel as a whole can be lifted and transported via truck or heavy cargo vehicles. The one or more flanged inlets and outlets are sized and positioned to accommodate the corresponding feedstock provision piping and product outlet piping of the Plant. One or both of the reactor vessel head pieces can be flanged and removable using a suitably sized head flange 110. A removable reactor vessel head piece may be desirable because it may facilitate the loading and unloading of the internal structures, including but not limited to trays, perforated support plates, catalyst beds, structured catalyst beds, Raschig rings, Dixon rings, and combinations of these, at a location away from the active plant (i.e. in a warehouse or other controlled environment). Modular Reactor Systems such as the one described above contained within an ISO 40 ft. container frame have been modeled in the process to have a name plate capacity between 1600 bpd and 2400 bpd of HSFO. Thus when utilized in combinations together in a matrix of reactors (as disclosed herein) expansion of capacity become simply a matter of having pre-designed the supporting utilities (i.e. piping, pumps, controls, etc. to accommodate the addition of new reactors to the Plant. For example, a set of three rectors set in series, the first reactor containing HDM catalyst loading, the second reactor containing HDT catalyst loading and the third reactor containing HDS catalyst loading, is expected to have an overall throughput of approximately 2000 bpd. Doubling the capacity of the plant can be achieved by adding a second series of three reactors. In this way additional capacity can be quickly brought on-line or take off-line as needed.

To change out reactor vessels, the plant should be designed with a compliant safety zone around each modular reactor, so the plant can continue operations while the modular Reactor System to be replaced is brought out of service and replaced with a second Modular Reactor System. Within the processes of the present invention, the modular Reactor System to be changed out will be hydrocarbon freed, placed under nitrogen and passivated. Passivation may be by conventional means or it may be with a material that will harden at ambient conditions to allow for safely disconnecting and removal of the reactor vessel. A modular Reactor System filled with preconditioned catalyst will replace the removed reactor and conditioned and brought back on-line. Reactor vessel internals, decommissioned catalyst and the like in the replaced modular Reactor System can then be unloaded and recycled off-site or at a location more suitable for such activities. Replacement internals, thermal couple replacement, insulation material patching or replacement and other services can be performed, and catalyst materials can be loaded in the revamped modular Reactor System, under controlled conditions of temperature and humidity (and if necessary under nitrogen or other inert atmosphere) into the modular Reactor System prior to transport back to the Plant site. The refurbished modular Reactor System may be filled with a material that will harden at ambient conditions and melt when heated to secure and protect the catalyst and vessel internals during transportation, which is described below in greater detail. The encapsulation/solidification of the reactor internals will allow the modular Reactor System to be more easily transported via truck or rail and lifted into position and reconnected at the plant. It will be appreciated by those skilled in the art that the flanges must be sealed off with blind flange covers whenever the modular Reactor System is transported to and from the Plant or stored in reserve on-site. One of skill in the art will appreciate that disconnecting, removal, replacement and reconnecting a modular Reactor System may be facilitated by hydraulic lifts or platforms or frameworks designed to securely receive the modular Reactor System and then lift, reorient and appropriately align and reposition of the modular Reactor System to fit the piping within the Plant. It is within the scope of this invention to have a hydrotreating plant in which the primary hydrotreating reactors are removable and replaceable with a modular Reactor System such as that described herein.

Hydrotreatment catalysts utilized in the modular Reactor System generally comprise an amorphous or crystalline oxide support such as an alumina, a silica, a silica alumina, or a zeolite, on which at least one element from groups VIII and VI of the periodic table or a combination of a plurality of elements from these same groups is deposited, for example solids designated CoMo/Al₂O₃, NiMo/Al₂O₃ or NiW/Al₂O₃. They may be sulfided in advance to endow them with catalytic performances for hydrocarbon hydroconversion reactions, and in particular hydrotreatment such as hydrodesulfurization, and, demetallization) and certain hydrogenation reactions. This sulfurization step carried out prior to the catalytic step can be carried out in two manners. In situ sulfurization is characterized in that the catalyst in its oxide form is initially charged into the hydrocarbon conversion reactor for sulfurizing. Ex situ pre-sulfurization, as described in U.S. Pat. Nos. 4,719,195; 5,397,756; 7,582,587 incorporated by reference) pre-sulfurization of the catalyst is carried out in a location different from the location in which the catalyst operates. One of skill in the art will appreciate that the catalyst can be pre-sulfided and passivated ex situ prior to loading into the transportable reactor, or after it has been loaded to prevent self-heating which may lead to spontaneous combustion. The processes of pre-sulfiding and passivation have been described in the technical and patent literature, and are well known to one of skill in the art.

For this disclosure, the term “sulfided metal particles” refers to metal oxide particles converted to the sulfide form. Further, the term “metal(s)” includes metal oxide(s) in partially reduced form. The term “pre-sulfided catalyst(s)” refers to catalysts wherein part of the metals are in the oxide form, and part of the metals may have been converted to the sulfide form. Pre-sulfided catalysts typically contain additional sulfur compounds which facilitate the sulfiding of the remaining metal oxides during the startup process. The term “pre-sulfided catalyst(s)” refers to catalysts wherein the majority of the metal oxides have been converted to metal sulfides.

As part of the ex situ passivation and optional coating of a catalyst, the sulfided catalyst undergoes at least two treatments: controlled contact with at least one surface active oxidizing agent (also called the passivation step), followed (optionally) by contact with at least one coating agent with an initial melting point of over 100° C., which coats the surfaces of the catalyst (also called the coating step). The word “coating” or “coated” does not rule out some reaction leading to passivation of the catalyst surfaces.

The passivation step involves the controlled contacting of the pre-sulfided catalyst with a surface active oxidizing agent, such as oxygen and/or an oxygen-containing hydrocarbon having at least 12 carbon atoms, for a sufficient time so a sulfurized catalyst is made less spontaneously combustible.

When the first passivation step is a treatment in the presence of a gas (or gas stream) containing oxygen (for example deriving from dry or moist air) which can advantageously be carried out at ambient temperature. The reaction of oxygen adsorption onto the catalyst causes an exothermic effect preferably controlled so the temperature of the product remains below 50° C. One possibility is to control the partial pressures of oxygen admitted to the catalyst. Then, a preferred manner of carrying out the invention is to initially treat the catalyst with a gas at a partial pressure of less than 8 kPa of oxygen, and secondly with a gas at a partial pressure of over 8 kPa of oxygen. It is also possible to carry out the oxidizing passivation process directly with one or more gas streams having a partial pressure of oxygen of over 8 kPa. This first stage preferably ends when the exothermic effect has all but disappeared (i.e. when the temperature of the solid no longer increases or only increases slightly) or, if the operator has means for limiting the temperature increase, the second stage of coating can then be started earlier.

When using an oxygen containing hydrocarbon in the first passivation step, the contact temperature is greater than about 0° C. and typically will range from about 15° C. to about 350° C., preferably from about 20° C. to about 150° C. The contact temperature will vary depending on the melting point or sublimation temperature of the oxygen-containing hydrocarbon. For example, when the oxygen-containing hydrocarbon is a solid or a semi-solid such as lard, the oxygen-containing hydrocarbon process temperature should preferably be at least at a temperature of the melting point of the solid or semi-solid for a time sufficient for the catalyst to flow freely (appear “dry” and not stick or clump). In a specific example of lard as the oxygen-containing hydrocarbon, the lard is preferably contacted at a initial temperature of about 80° C. The process temperature for contacting the oxygen-containing hydrocarbon and catalyst can be readily determined by the melting point of the solid or semi-solid at a given pressure environment or visually by checking if the oxygen-containing hydrocarbon flows. Contact times will depend on temperature and the viscosity of the oxygen-containing hydrocarbon, higher temperatures requiring shorter times and higher viscosity requiring longer times. Times will range from about 2 minutes to about 2 hours, although longer contact times can also be used.

Preferably the oxygen-containing hydrocarbon is sufficiently flowable to give a sufficient contact with the catalyst. An oxygen-containing hydrocarbon which is liquid at the elevated temperature of contact is more preferred for ease of handling. It is preferred that the oxygen-containing hydrocarbon is a higher hydrocarbon, i.e., one having a carbon number greater than twelve, preferably greater than sixteen, more preferably greater than twenty. The upper carbon number of useful oxygen-containing hydrocarbon is determined by the melting point, solidification point, or smoke point of this oxygen-containing hydrocarbon. While solid fatty oxygen-containing hydrocarbon having carbon numbers greater than 100 can be used, they are inconvenient since they must be heated to such a high temperature to be converted into a liquid, although they can be used with a solvent to put them in liquid form. Oxygen-containing hydrocarbons with carbon numbers within the range from about 12 to about 100, preferably from about 16 to about 80 are found most useful.

The term “oxygen-containing hydrocarbon” refers to hydrocarbon molecules containing at least one oxygen atom, which includes, for example, acids, acid esters, alcohols, aldehydes, ketones and ethers. The oxygen-containing hydrocarbon may be mixtures such as acid esters and alcohols, different acid esters and the like. The oxygen-containing hydrocarbon can be primary, secondary or tertiary. The hydrocarbon moiety can be straight or branched chain carbon atom linkages, cyclic, acyclic or aromatic. The hydrocarbon moiety can further be saturated or unsaturated. Oxygen-containing hydrocarbons include, for example, higher alcohols having at least 12, preferably 16, more preferably 20 carbon atoms such as dodecanol, hexadecanol, farnesol, hexestrol, oleyl alcohol, cetyl alcohol, hexacosanol, triacontanol, cocceryl alcohol and octacosanol; higher ethers having at least 12, preferably 16, more preferably 20 carbon atoms such as dicetyl ether; higher ketones having at least 12 carbon atoms, preferably 16 carbon atoms, more preferably 20 carbon atoms such as palmitone, 10-hydroxypalmitone and 3-octadecanone; higher aldehydes having at least 12 carbon atoms, preferably 16, more preferably 20 carbon atoms such as palmitaldehyde and olealdehyde; higher acids having at least 12, preferably 16, more preferably 20 carbon atoms such as saturated acids such as lauric, myristic, palmitic, stearic, and docosanoic acids for example, or unsaturated higher acids such as palmitoleic, oleic, linoleic, linolenic, eleostearic, ricinoleic, eicosenoic, docosenoic, eicosatetraenoic, eicosapentaenoic, decosapentaenoic and docosahexaenoic; higher acid esters having at least 12, preferably 16, more preferably 20 carbon atoms including mono-, di-, tri-and poly-fatty acid esters including alkyl and aryl esters of the above acids (e.g. benzyl oleate and butyl oleate) and esters of the above acids with mono-glyceride, di-glycerides and triglycerides and mixtures thereof. These glyceride fatty acid esters having from 16 to 100, more preferably 18 to 90, most preferably 20 to 80 carbon atoms are preferred. Some examples of commercial glyceride fatty acid esters include soybean oil, linseed oil, safflower oil, corn oil, sunflower oil, cottonseed oil, olive oil, tung oil, castor oil, rapeseed oil, tall oil, peanut oil, coconut oil, palm oil, canbra oil, perilla oil, lard, tallow, marine fat or oil such as fish fat or oil (e.g. herring and sardine), vegetable residues and mixtures thereof. Some examples of commercial higher alcohols includes alkanol mixtures such as NEODOL™ alcohols from Shell Chemical Company, including mixtures of C₉, C₁₀ and C₁₁ alkanols (NEODOL™ 91 Alcohol), mixtures of C₁₂ and C₁₃ alkanols (NEODOL™ 23 Alcohol), mixtures of C₁₂, C₁₃, C₁₄ and C₁₅ alkanols (NEODOL™ 25 Alcohol), and mixtures of C₁₄ and C₁₅ alkanols (NEODOL™ 45 Alcohol); the ALFOL™ Alcohols from Vista Chemical Company, including mixtures of Cio and C₁₂ alkanols (ALFOL™ 1012 Alcohol), mixtures of C₁₂ and C₁₄ alkanols (ALFOL™ 1214 Alcohol), mixtures of C₁₆ and C₁₈ alkanols (ALFOL™ 1618Alcohol) and mixtures of C₁₆, C₁₈, and C₂₀ alkanols (ALFOL™ 1620 Alcohol); the EPAL™ Alcohols from Ethyl Chemical Company, including mixtures of C₁₀ and C₁₂alkanols (EPAL™ 1012 Alcohol), mixtures of C₁₂ and C₁₄ alkanols (EPAL™ 1214 Alcohol) and mixtures of C₁₄, C₁₆, and C₁₈ alkanols (EPAL™ 1418 Alcohol); and the TERGITOL-™ Alcohols from Union Carbide Corporation, including mixtures of C₁₂, C₁₃, C₁₄ and C₁₅ alkanols (TERGITOL-L™ 125 Alcohols). Suitable commercially available alkanols prepared by the reduction of naturally occurring fatty acid esters includes for example, the CO and TA products of Procter and Gamble Company and the TA alcohols of Ashland Oil Company. Higher oligomers and polymers of polyols such as alkylene glycols are also suitable as higher alcohols.

The optional coating treatment will involve the treatment of the passivated catalyst material with a long chain waxy hydrocarbon or polymer material to further protect the sulfided catalyst from deactivation. The coating agent should have a melting point no less than the maximum ambient air temperature (i.e. greater than about 60° C.) and more preferably will have a melting point of over 80° C. to facilitate transportation without premature melting. Waxy hydrocarbons should be sufficiently hard (or crystalline) so the coated catalyst particles can be formed into a solid mass. However not so hard that the solid mass becomes brittle or subject to cracking during transport. Waxes made from higher alkanes having a C₁₅-C₂₀ chain lengths should be sufficient, with some limited branching. Waxes made from lipids or fatty acids or primary or secondary long chain alcohols will also be useful. Long chain alcohols may also serve as the passivating agent disclosed above. Ideally, the wax material will have a melting point above 80° C., but lower than the lowest desired operating temperatures for the process (i.e. lower than 260° C.) to facilitate removal from the catalyst materials. Generally upon exposure of the wax materials to elevated temperatures and a partial pressure of hydrogen, they are thermally hydrocracked and rapidly removed from the active sulfided catalyst materials. In an alternative embodiment, the coating material may be polymeric, preferably a heat sensitive polymer such thermoplastics examples of which include polyethylene, polypropylene or poly butylene. One of skill in the art will appreciate that the chain length and structure (iso-tactic v. syn-tactic v atactic) nature of the polymer chain will directly affect the properties and can be adjusted systematically to obtain the desired properties.

In one embodiment of the invention, the passivation step is completed, and the catalyst will be sufficiently passivated for handling and loading of the catalyst under controlled conditions of temperature, oxygen content (i.e. under an oxygen depleted atmosphere such as nitrogen or argon) and humidity. In such instances, the passivated (but not coated) catalyst will be loaded into the transportable reactor to form catalyst beds and/or will be loaded into the support structures of the pre-structured catalyst bed. This will allow the second step of coating to take place in the fully catalyst loaded transportable reactor itself or (with structured supports) the coating process will be performed on the catalyst loaded structured supports outside of the transportable reactor, so the coated catalyst loaded structured bed elements can be loaded into the transportable reactor.

Activation of the ex-situ pre-sulfided catalyst takes place in the transportable reactor once the transportable reactor is connected to the process infrastructure. The activation step may involve heating the reactor first to a temperature to melt or liquify the coating materials. The heating step will be performed under inert atmosphere (such as nitrogen or argon) which might have a measurable partial pressure of hydrogen. The heating step continues until the desired operating conditions of temperature and pressure are reached. This may require the introduction of a hydrocarbon (such as low sulfur diesel, marine gas oil, low sulfur residual materials in the presence of hydrogen and optionally a hydrocarbon. This process of pre-conditioning the catalyst and the transportable reactor prior to introducing Feedstock HMFO material

Oil Product Stripper System Description: The Oil Product Stripper System (19) comprises a stripper column (also known as a distillation column or exchange column) and ancillary equipment including internal elements and utilities required to remove hydrogen, hydrogen sulfide, by-product hydrocarbons (i.e. hydrocarbons boiling less than 150 F) and optionally hydrocarbons lighter than diesel from the Product HMFO. Such systems are well known to one of skill in the art, see U.S. Pat. Nos. 6,640,161; 5,709,780; 5,755,933; 4,186,159; 3,314,879 3,844,898; 4,681,661; or 3,619,377 the contents of which are incorporated herein by reference, a generalized functional description is provided herein. Liquid from the Hot Separator (13) and Cold Separator (7) feed the Oil Product Stripper Column (19). Stripping of hydrogen and hydrogen sulfide and by-product hydrocarbons and even hydrocarbons lighter than heavy diesel may be achieved via a reboiler, live steam or other stripping medium. The Oil Product Stripper System (19) may be designed with an overhead system comprising an overhead condenser, reflux drum and reflux pump or it may be designed without an overhead system. The conditions of the Oil Product Stripper may be optimized to control the bulk properties of the Product HMFO, more specifically viscosity and density. It is contemplated that a second draw (not shown) may be included to withdraw a diesel product, preferably a middle to heavy distillate, and by doing so control the viscosity, density and CCAI of the Product HMFO. Modifications and alternative embodiments of the Oil Product Stripper System are contemplated and are well within the capability of a skilled person and can be made to “upgrade” the Product HMFO to be less viscous and less dense (and potentially more valuable grades of residual marine fuel) or even to down grade the Product HMFO by making the the Product HMFO more viscous and more dense (i.e. RMG or RMK grades) while recovering the more valuable diesel (gas oil) fractions.

Amine Absorber System Description: The Amine Absorber System (21) comprises a gas liquid contacting column and ancillary equipment and utilities required to remove sour gas (i.e. hydrogen sulfide) from the Cold Separator vapor feed so the resulting scrubbed gas can be recycled and used as Activating Gas. Because such systems are well known to one of skill in the art, see U.S. Pat. Nos. 4,425,317; 4,085,199; 4,080,424; 4,001,386; which are incorporated herein by reference, a generalized functional description is provided herein. Vapors from the Cold Separator (17) feed the contacting column/system (19). Lean Amine (or other suitable sour gas stripping fluids or systems) provided from OSBL is utilized to scrub the Cold Separator vapor so hydrogen sulfide is effectively removed. The Amine Absorber System (19) may be designed with a gas drying system to remove the any water vapor entrained into the Recycle Activating Gas (C′). The absorbed hydrogen sulfide is processed using conventional means OSBL in a tail gas treating unit, such as a Claus combustion sulfur recovery unit or sulfur recovery system that generates sulfuric acid.

These examples will provide one skilled in the art with a more specific illustrative embodiment for conducting the process disclosed and claimed herein:

### Example 1

Overview: The purpose of a pilot test run is to demonstrate that a Feedstock HMFO that is compliant with ISO 8217:2017 Table 2 as a residual marine fuel can be processed through a reactor loaded with commercially available catalysts at specified conditions to remove Environmental Contaminants, specifically sulfur and other contaminants from the Feedstock HMFO to produce a Product HMFO that is compliant with ISO 8217:2017 as a Table 2 residual marine fuel, but also MARPOL compliant, that is production of a Low Sulfur Heavy Marine Fuel Oil (LS-HMFO) or Ultra-Low Sulfur Heavy Marine Fuel Oil (USL-HMFO) by subjecting a Feedstock HMFO to hydrodemetallization and hydrodesulfurization conditions.

Pilot Unit Set Up: The pilot unit will be set up with two 434 cm³ reactors arranged in series to process the Feedstock HMFO. The lead reactor will be loaded with a blend of a commercially available hydrodemetallization (HDM) catalyst and a commercially available hydro-transition (HDT) catalyst. One of skill in the art will appreciate that the HDT catalyst layer may be formed and optimized using a mixture of HDM and HDS catalysts combined with an inert material to achieve the desired intermediate/transition activity levels. The second reactor will be loaded with a blend of the commercially available hydro-transition (HDT) and a commercially available hydrodesulfurization (HDS). One can optionally load the second reactor simply with a commercially hydrodesulfurization (HDS) catalyst. One of skill in the art will appreciate that the specific properties of the Feedstock HMFO may affect the proportion of HDM, HDT and HDS catalysts in the reactor system. A systematic process of testing different combinations with the same feed will yield the optimized catalyst combination for any feedstock and reaction conditions. For this example, the first reactor will be loaded with 2/3 hydrodemetallization catalyst and 1/3 hydro-transition catalyst. The second reactor will be loaded with all hydrodesulfurization catalyst. The catalysts in each reactor will be mixed with glass beads (approximately 50% by volume) to improve liquid distribution and better control reactor temperature. For this pilot test run, one should use these commercially available catalysts: HDM: Albemarle KFR 20 series or equivalent; HDT: Albemarle KFR 30 series or equivalent; HDS: Albemarle KFR 50 or KFR 70 or equivalent. Once set up of the pilot unit is complete, the catalyst can be activated by sulfiding the catalyst using dimethyldisulfide (DMDS) in a manner well known to one of skill in the art.

Pilot Unit Operation: Upon completion of the activating step, the pilot unit will be ready to receive the Feedstock HMFO and Activating Gas. For the present example, the Activating Gas can be technical grade or better hydrogen gas. The mixed Feedstock HMFO and Activating Gas will be provided to the pilot plant at rates and operating conditions as specified: Oil Feed Rate: 108.5 ml/h (space velocity=0.25/h); Hydrogen/Oil Ratio: 570 Nm3/m3 (3200 scf/bbl); Reactor Temperature: 372° C. (702° F.); Reactor Outlet Pressure: 13.8 MPa (g) (2000 psig).

One of skill in the art will know that the rates and conditions may be systematically adjusted and optimized depending upon feed properties to achieve the desired product requirements. The unit will be brought to a steady state for each condition and full samples taken so analytical tests can be completed. Material balance for each condition should be closed before moving to the next condition.

Expected impacts on the Feedstock HMFO properties are: Sulfur Content (wt %): Reduced by at least 80%; Metals Content (wt %): Reduced by at least 80%; MCR/Asphaltene Content (wt %): Reduced by at least 30%; Nitrogen Content (wt %): Reduced by at least 20%; C1-Naphtha Yield (wt %): Not over 3.0% and preferably not over 1.0%.

Process conditions in the Pilot Unit can be systematically adjusted as per Table 1 to assess the impact of process conditions and optimize the performance of the process for the specific catalyst and Feedstock HMFO utilized.

TABLE 1
Optimization of Process Conditions

| | HC Feed Rate | | | |
|---|---|---|---|---|
| | (ml/h), | Nm³ H₂/m³ oil/ | Temp | Pressure |
| Case | [LHSV (/h)] | scf H₂/bbl oil | (° C./° F.) | (MPa(g)/psig) |
| Baseline | 108.5 [0.25] | 570/3200 | 372/702 | 13.8/2000 |
| T1 | 108.5 [0.25] | 570/3200 | 362/684 | 13.8/2000 |
| T2 | 108.5 [0.25] | 570/3200 | 382/720 | 13.8/2000 |
| L1 | 130.2 [0.30] | 570/3200 | 372/702 | 13.8/2000 |
| L2 | 86.8 [0.20] | 570/3200 | 372/702 | 13.8/2000 |
| H1 | 108.5 [0.25] | 500/2810 | 372/702 | 13.8/2000 |
| H2 | 108.5 [0.25] | 640/3590 | 372/702 | 13.8/2000 |
| S1 | 65.1 [0.15] | 620/3480 | 385/725 | 15.2/2200 |

In this way, the conditions of the pilot unit can be optimized to achieve less than 0.5% wt. sulfur Product HMFO and preferably a 0.1% wt. sulfur Product HMFO. Conditions for producing ULS-HMFO (i.e. 0.1% wt. sulfur Product HMFO) will be: Feedstock HMFO Feed Rate: 65.1 ml/h (space velocity=0.15/h); Hydrogen/Oil Ratio: 620 Nm³/m³ (3480 scf/bbl); Reactor Temperature: 385° C. (725° F.); Reactor Outlet Pressure: 15 MPa (g) (2200 psig)

Table 2 summarizes the anticipated impacts on key properties of HMFO.

TABLE 2
Expected Impact of Process on Key Properties of HMFO

| Property | Minimum | Typical | Maximum |
|---|---|---|---|
| Sulfur Conversion/Removal | 80% | 90% | 98% |
| Metals Conversion/Removal | 80% | 90% | 100% |
| MCR Reduction | 30% | 50% | 70% |
| Asphaltene Reduction | 30% | 50% | 70% |
| Nitrogen Conversion | 10% | 30% | 70% |
| C1 through Naphtha Yield | 0.5% | 1.0% | 4.0% |
| Hydrogen Consumption (scf/bbl) | 500 | 750 | 1500 |

Table 3 lists analytical tests to be carried out for the characterization of the Feedstock HMFO and Product HMFO as being compliant with the properties set forth in ISO 8217:2017 Table 2. The analytical tests include those required by ISO for the Feedstock HMFO and the Product HMFO to qualify and trade in commerce as compliant with ISO 8217:2017 Table 2 as a residual marine fuel. The additional parameters are provided so that one skilled in the art can understand and appreciate the effectiveness of the inventive process and the minimization of hydrocracking as evidenced by the very low production of light hydrocarbons and wild naphtha (i.e. hydrocarbons boiling below 150 F).

TABLE 3
Analytical Tests and Testing Procedures

| | |
|---|---|
| Sulfur Content | ISO 8754 or ISO 14596 or ASTM |
| | D4294 |
| Density @ 15° C. | ISO 3675 or ISO 12185 |
| Kinematic Viscosity @ 50° C. | ISO 3104 |
| Pour Point, ° C. | ISO 3016 |
| Flash Point, ° C. | ISO 2719 |
| CCAI | ISO 8217, ANNEX B |
| Ash Content | ISO 6245 |
| Total Sediment-Aged | ISO 10307-2 |
| Micro Carbon Residue, mass % | ISO 10370 |
| H2S, mg/kg | IP 570 |
| Acid Number | ASTM D664 |
| Water | ISO 3733 |
| Specific Contaminants | IP 501 or IP 470 (unless indicated |
| | otherwise) |
| Vanadium | or ISO 14597 |
| Sodium | |
| Aluminum | or ISO 10478 |
| Silicon | or ISO 10478 |
| Calcium | or IP 500 |
| Zinc | or IP 500 |
| Phosphorous | IP 500 |
| Nickle | |
| Iron | |
| Distillation | ASTM D7169 |
| C:H Ratio | ASTM D3178 |
| SARA Analysis | ASTM D2007 |
| Asphaltenes, wt % | ASTM D6560 |
| Total Nitrogen | ASTM D5762 |
| Vent Gas Component Analysis | FID Gas Chromatography or comparable |

Table 4 contains the Feedstock HMFO analytical test results and the Product HMFO analytical test results expected from the inventive process that indicate the production of a LS HMFO. It will be noted by one of skill in the art that under the conditions, the levels of hydrocarbon cracking will be minimized to levels substantially lower than 10%. more preferably less than 5% and even more preferably less than 1% of the total mass balance.

TABLE 4
Analytical Results

| | Feedstock HMFO | Product HMFO |
|---|---|---|
| Sulfur Content, mass % | 3.0 | 0.3 |
| Density @ 15 C., kg/m³ | 990 | 950 ⁽¹⁾ |
| Kinematic Viscosity @ 50 C., mm²/s | 380 | 100 ⁽¹⁾ |
| Pour Point, C. | 20 | 10 |
| Flash Point, C. | 110 | 100 ⁽¹⁾ |
| CCAI | 850 | 820 |
| Ash Content, mass % | 0.1 | 0.0 |
| Total Sediment-Aged, mass % | 0.1 | 0.0 |
| Micro Carbon Residue, mass % | 13.0 | 6.5 |
| H2S, mg/kg | 0 | 0 |
| Acid Number, mg KO/g | 1 | 0.5 |
| Water, vol % | 0.5 | 0 |
| Specific Contaminants, mg/kg | | |
| Vanadium | 180 | 20 |
| Sodium | 30 | 1 |
| Aluminum | 10 | 1 |
| Silicon | 30 | 3 |
| Calcium | 15 | 1 |
| Zinc | 7 | 1 |
| Phosphorous | 2 | 0 |
| Nickle | 40 | 5 |
| Iron | 20 | 2 |
| Distillation, ° C./° F. | | |
| IBP | 160/320 | 120/248 |
| 5% wt | 235/455 | 225/437 |
| 10% wt | 290/554 | 270/518 |
| 30% wt | 410/770 | 370/698 |
| 50% wt | 540/1004 | 470/878 |
| 70% wt | 650/1202 | 580/1076 |
| 90% wt | 735/1355 | 660/1220 |
| FBP | 820/1508 | 730/1346 |
| C:H Ratio (ASTM D3178) | 1.2 | 1.3 |
| SARA Analysis | | |
| Saturates | 16 | 22 |
| Aromatics | 50 | 50 |
| Resins | 28 | 25 |
| Asphaltenes | 6 | 3 |
| Asphaltenes, wt % | 6.0 | 2.5 |
| Total Nitrogen, mg/kg | 4000 | 3000 |

Note:
⁽¹⁾ It is expected that property will be adjusted to a higher value by post process removal of light material via distillation or stripping from Product HMFO.

The Product HMFO produced by the inventive process will reach ULS HMFO limits (i.e. 0.1% wt. sulfur Product HMFO) by systematic variation of the process parameters, for example by a lower space velocity or by using a Feedstock HMFO with a lower initial sulfur content.

### Example 2

### RMG-380 HMFO

Pilot Unit Set Up: A pilot unit was set up as noted above in Example 1 with these changes: the first reactor was loaded with: as the first (upper) layer encountered by the feedstock 70% vol Albemarle KFR 20 series hydrodemetallization catalyst and 30% vol Albemarle KFR 30 series hydro-transition catalyst as the second (lower) layer. The second reactor was loaded with 20% Albemarle KFR 30 series hydrotransition catalyst as the first (upper) layer and 80% vol hydrodesulfurization catalyst as the second (lower) layer. The catalyst was activated by sulfiding the catalyst with dimethyldisulfide (DMDS) in a manner well known to one of skill in the art.

Pilot Unit Operation: Upon completion of the activating step, the pilot unit was ready to receive the Feedstock HMFO and Activating Gas feed. The Activating Gas was technical grade or better hydrogen gas. The Feedstock HMFO was a commercially available and merchantable ISO 8217:2017 compliant HMFO, except for a high sulfur content (2.9 wt %). The mixed Feedstock HMFO and Activating Gas was provided to the pilot plant at rates and conditions as specified in Table 5 below. The conditions were varied to optimize the level of sulfur in the Product HMFO material.

TABLE 5
Process Conditions

| | | | | | Product |
|---|---|---|---|---|---|
| | HC Feed | Nm³ | | Pressure | HMFO |
| | Rate (ml/h), | H₂/m³ oil/ | Temp | (MPa | Sulfur |
| Case | [LHSV (/h)] | scf H₂/bbl oil | (° C./° F.) | (g)/psig) | % wt. |
| Baseline | 108.5 [0.25] | 570/3200 | 371/700 | 13.8/2000 | 0.24 |
| T1 | 108.5 [0.25] | 570/3200 | 362/684 | 13.8/2000 | 0.53 |
| T2 | 108.5 [0.25] | 570/3200 | 382/720 | 13.8/2000 | 0.15 |
| L1 | 130.2 [0.30] | 570/3200 | 372/702 | 13.8/2000 | 0.53 |
| S1 | 65.1 [0.15] | 620/3480 | 385/725 | 15.2/2200 | 0.10 |
| P1 | 108.5 [0.25] | 570/3200 | 371/700 | /1700 | 0.56 |
| T2/P1 | 108.5 [0.25] | 570/3200 | 382/720 | /1700 | 0.46 |

Analytical data for a representative sample of the Feedstock HMFO and representative samples of Product HMFO are below:

TABLE 6
Analytical Results-HMFO (RMG-380)

| | Feedstock | Product | Product |
|---|---|---|---|
| Sulfur Content, mass % | 2.9 | 0.3 | 0.1 |
| Density @ 15° C., kg/m³ | 988 | 932 | 927 |
| Kinematic Viscosity @ 50° C., | 382 | 74 | 47 |
| mm²/s | | | |
| Pour Point, ° C. | −3 | −12 | −30 |
| Flash Point, ° C. | 116 | 96 | 90 |
| CCAI | 850 | 812 | 814 |
| Ash Content, mass % | 0.05 | 0.0 | 0.0 |
| Total Sediment-Aged, mass % | 0.04 | 0.0 | 0.0 |
| Micro Carbon Residue, mass % | 11.5 | 3.3 | 4.1 |
| H2S, mg/kg | 0.6 | 0 | 0 |
| Acid Number, mg KO/g | 0.3 | 0.1 | >0.05 |
| Water, vol % | 0 | 0.0 | 0.0 |
| Specific Contaminants, mg/kg | | | |
| Vanadium | 138 | 15 | <1 |
| Sodium | 25 | 5 | 2 |
| Aluminum | 21 | 2 | <1 |
| Silicon | 16 | 3 | 1 |
| Calcium | 6 | 2 | <1 |
| Zinc | 5 | <1 | <1 |
| Phosphorous | <1 | 2 | 1 |
| Nickle | 33 | 23 | 2 |
| Iron | 24 | 8 | 1 |
| Distillation, ° C./° F. | | | |
| IBP | 178/352 | 168/334 | 161/322 |
| 5% wt | 258/496 | 235/455 | 230/446 |
| 10% wt | 298/569 | 270/518 | 264/507 |
| 30% wt | 395/743 | 360/680 | 351/664 |
| 50% wt | 517/962 | 461/862 | 439/822 |
| 70% wt | 633/1172 | 572/1062 | 552/1026 |
| 90% wt | >720/>1328 | 694/1281 | 679/1254 |
| FBP | >720/>1328 | >720/>1328 | >720/>1328 |
| C:H Ratio (ASTM D3178) | 1.2 | 1.3 | 1.3 |
| SARA Analysis | | | |
| Saturates | 25.2 | 28.4 | 29.4 |
| Aromatics | 50.2 | 61.0 | 62.7 |
| Resins | 18.6 | 6.0 | 5.8 |
| Asphaltenes | 6.0 | 4.6 | 2.1 |
| Asphaltenes, wt % | 6.0 | 4.6 | 2.1 |
| Total Nitrogen, mg/kg | 3300 | 1700 | 1600 |

In Table 6 above, both Feedstock HMFO and Product HMFO exhibited properties consistent with ISO8217: 2017 Table 2 residual marine fuel, except that the sulfur content of the Feedstock HMFO was too high to comply with IMO 2020, and which was reduced as noted above in the Product HMFO.

One of skill in the art will appreciate that the above Product HMFO produced by the inventive process has achieved not only an ISO 8217:2017 Table 2 residual marine fuel marketable as a LS HMFO (i.e. 0.5% wt. sulfur) but also an ISO 8217:2017 Table 2 residual marine fuel marketable as a ULS HMFO limits (i.e. 0.1% wt. sulfur).

### Example 3

### RMK-500 HMFO

The feedstock to the pilot reactor utilized in example 2 above was changed to a commercially available and merchantable ISO 8217:2017 Table 2 residual marine fuel classified as an RMK-500 compliant high sulfur HMFO, that is it has high Environmental Contaminants (i.e. sulfur (3.3 wt %)). Other pertinent characteristics of the RMK-500 feedstock high sulfur HMFO are provide below:

TABLE 7
Analytical Results- Feedstock HMFO (RMK-500)

| | |
|---|---|
| Sulfur Content, mass % | 3.3 |
| Density @ 15° C., kg/m³ | 1006 |
| Kinematic Viscosity @ 50° C., mm²/s | 500 |

The mixed Feedstock (RMK-500) HMFO and Activating Gas was provided to the pilot plant at rates and conditions and the resulting sulfur levels achieved in the table below

TABLE 8
Process Conditions

| | HC Feed | Nm³ H₂/m³ | | Pressure | Product |
|---|---|---|---|---|---|
| | Rate (ml/h), | oil/scf | Temp | (MPa (g)/ | (RMK-500) |
| Case | [LHSV (/h)] | H₂/bbl oil | (° C./° F.) | psig) | sulfur % wt. |
| A | 108.5 [0.25] | 640/3600 | 377/710 | 13.8/2000 | 0.57 |
| B | 95.5 [0.22] | 640/3600 | 390/735 | 13.8/2000 | 0.41 |
| C | 95.5 [0.22] | 640/3600 | 390/735 | 11.7/1700 | 0.44 |
| D | 95.5 [0.22] | 640/3600 | 393/740 | 10.3/1500 | 0.61 |
| E | 95.5 [0.22] | 640/3600 | 393/740 | 17.2/2500 | 0.37 |
| F | 95.5 [0.22] | 640/3600 | 393/740 | 8.3/1200 | 0.70 |
| G | 95.5 [0.22] | 640/3600 | 416/780 | 8.3/1200 | |

The resulting Product (RMK-500) HMFO exhibited observed bulk properties consistent with the Feedstock (RMK-500) HMFO (i.e. compliance with ISO 8217:2017 Table 2 as a residual marine fuel, except that the sulfur content was reduced as noted in the above table.

One of skill in the art will appreciate that the above Product HMFO produced by the inventive process has achieved a LS HMFO (i.e. 0.5% wt. sulfur) Product HMFO having bulk characteristics of a ISO 8217:2017 Table 2 residual marine fuel classified as a compliant RMK-500 residual fuel oil. It will also be appreciated that the process can be successfully carried out under hydrodesulfurization and hydrodemetallization conditions (i.e. lower temperature and pressure) that substantially reduce the hydrocracking of the feedstock material. The prior art teaches that these conditions are not suitable for heavy oils in such reactions as they would lead to rapid coking and deactivation of the catalyst. Clearly that is not the result when an ISO 8217:2017 Table 2 compliant feedstock is utilized. When conditions were increased to much higher pressure (Example E) a product with a lower sulfur content was achieved, however it was observed that there was an increase in light hydrocarbons and wild naphtha production and increased coking of the catalyst.

It will be appreciated by those skilled in the art that changes could be made to the illustrative embodiments described above without departing from the broad inventive concepts thereof. It is understood, therefore, that the inventive concepts disclosed are not limited to the illustrative embodiments or examples disclosed, but it is intended to cover modifications within the scope of the inventive concepts as defined by the claims.

1. A structured catalyst bed comprising:
a. At least two catalyst retention structures, wherein each catalyst retention structure is composed of at least one flat fluid permeable metal sheet and at least one corrugated fluid permeable metal sheet aligned to be co-planar and spatially arranged to define at least one catalyst rich space and at least one catalyst lean space, wherein the at least one catalyst rich space contains one or more catalyst material, wherein the one or more catalyst material is selected from the group consisting of: a porous inorganic oxide catalyst carrier impregnated with at least one transition metal catalyst and having hydrocarbon hydrodemetallization activity under reactive conditions of hydrocarbon hydrodemetallization; a porous inorganic oxide catalyst carrier impregnated with at least one transition metal catalyst and having hydrocarbon hydrodenitrogenation activity under reactive conditions of hydrocarbon hydrodenitrogenation, a porous inorganic oxide catalyst carrier impregnated with at least one transition metal catalyst and having hydrocarbon hydrodesulfurization activity under reactive conditions of hydrocarbon hydrodesulfuization, a porous inorganic oxide catalyst carrier impregnated with at least one transition metal catalyst and having a combination of hydrocarbon hydrodemetallization and hydrocarbon hydrodesulfurization activity under reactive conditions of hydrodemetallization and hydrodesulfurization, and combinations of these, wherein the one or more catalyst material selected has been ex situ pre-sulfided and passivated and;
b. wherein the at least two adjacent catalyst retention structures are aligned in parallel X-Y planes, but the catalyst rich spaces of each catalyst retention structure define an angle of radial alignment in the X-Y plane of greater than 0° and less than 180°.

2. The device of claim 1, wherein the one or more catalyst material selected has been ex situ pre-sulfided and passivated before loading into the catalyst rich space of the catalyst retention structures.

3. The device of claim 1, wherein the one or more catalyst material selected has been ex situ pre-sulfided and passivated after loading into the catalyst rich space of the catalyst retention structures.

4. The device of claim 1, wherein the one or more catalyst material selected has been ex situ pre-sulfided and passivated with an oxygen containing hydrocarbon.

5. The device of claim 1 wherein the one or more catalyst material selected has been ex situ pre-sulfided and passivated with an oxygen containing hydrocarbon and subsequently coated with a long chain waxy hydrocarbon or polymer material to further protect the sulfided catalyst from deactivation.

6. The device of claim 5 wherein the long chain waxy hydrocarbon or polymer material has a melting point greater than about 60° C.

7. The device of claim 1, wherein the porous inorganic oxide catalyst carrier is at least one carrier selected from the group consisting of alumina, alumina/boria carrier, a carrier containing metal-containing aluminosilicate, alumina/phosphorus carrier, alumina/alkaline earth metal compound carrier, alumina/titania carrier and alumina/zirconia carrier, and wherein the transition metal catalyst is one or more metals selected from the group consisting of group 6, 8, 9 and 10 of the Periodic Table.

8. The device of claim 1, wherein the at least one catalyst rich space additionally contains catalytically inert materials selected from the group consisting of ceramic beads, inactive catalyst support, glass beads, rings, wire balls, plastic balls and combinations thereof.

9. The device of claim 1, wherein the at least one catalyst lean space contains catalytically inert materials selected from the group consisting of ceramic beads, inactive catalyst support, glass beads, rings, wire balls, plastic balls and combinations thereof.

10. The device of claim 1, wherein the flat fluid permeable metal sheet is selected from the group consisting of: woven metal wire mesh, perforated metal plate; sintered porous metal plate, and combinations thereof.

11. The device of claim 1, wherein the corrugated fluid permeable metal sheet is selected from the group consisting of: woven metal wire mesh, perforated metal plate; sintered porous metal plate, and combinations thereof, and the shape of the corrugations are selected from the group of shapes consisting of sine wave form, square wave form, triangle wave form and sawtooth wave form.

12. The device of claim 1, wherein the at least two adjacent catalyst retention structures are aligned in parallel X-Y planes, but the catalyst rich spaces of one catalyst retention structure defines an first inclination angle relative to the X-Y plane greater than 0° and less than 180° and the catalyst rich spaces of the second catalyst retention structure defines an second inclination angle relative to the X-Y plane greater than 0° and less than 180° but that is different from the first inclination angle.

13. A device for the production of a Product Heavy Marine Fuel Oil, the device comprising: a feed mixing unit for mixing a quantity of Feedstock Heavy Marine Fuel Oil wherein the Feedstock Heavy Marine Fuel Oil is compliant with ISO 8217:2017 as a residual marine fuel except for the sulfur content (ISO 14596 or ISO 8754) of the Feedstock Heavy Marine Fuel Oil, with a quantity of Activating Gas to give a Feedstock Mixture; a Reaction System in fluid communication with the feed mixing unit for receiving the Feedstock Mixture, wherein the Reaction System comprises one or more reactor vessels wherein said reactor vessels contains one or more structured catalyst beds containing one or more catalyst materials selected form the group consisting of hydrodemetallization catalyst, hydro-transition catalysts, hydrodesulfurization catalyst and combinations thereof, and wherein the Reaction System is under hydrotreating reactive distillation conditions to catalytically react the Feedstock Mixture into a Process Mixture containing the Product Heavy Marine Fuel Oil and separate by distillation the Product Heavy Marine Fuel Oil from the Process Mixture such that the Product Heavy Marine Fuel Oil leaving the bottom of each reactor vessel is at least 75% by mass of the Process Mixture; at least one separating vessel in fluid communication with the Reaction System, the at least one receiving vessel in fluid communication with the Reaction system and configured to receive the Product Heavy Marine Fuel Oil from the Reaction System and subsequently discharging the Product Heavy Marine Fuel Oil.

14. The device of claim 5, wherein the Product Heavy Marine Fuel Oil complies with ISO 8217 (2017) Table 2 as a residual marine fuel and has a sulfur content (ISO 14596 or ISO 8754) between the range of 0.50 mass % to 0.05 mass %.

15. A process for the production of a Product Heavy Marine Fuel Oil, the process comprising: mixing a quantity of Feedstock Heavy Marine Fuel Oil, wherein the Feedstock Heavy Marine Fuel Oil is compliant with ISO 8217:2017 Table 2 as a residual marine fuel except for the sulfur content (ISO 14596 or ISO 8754), with a quantity of Activating Gas to give a Feedstock Mixture; contacting the Feedstock Mixture in at least one reactive distillation vessel with one or more catalysts under reactive conditions to promote the formation of a Process Mixture from said Feedstock Mixture, wherein said one or more catalysts are in the form of a structured catalyst bed withing the at least one reactive distillation vessel; and wherein the combination of the reactive conditions and the structured catalyst bed within the at least one reactive distillation vessel separate by distillation the Product Heavy Marine Fuel Oil from the Process Mixture such that the mass of the Product Heavy Marine Fuel Oil leaving the bottom of the at least one reactive distillation vessel is at least 75% by mass of the Process Mixture, receiving the Product Heavy Marine Fuel Oil leaving the bottom of the at least one reactive distillation vessel in at least one receiving vessel in fluid communication with the at least one reactive distillation vessel and subsequently discharging the Product Heavy Marine Fuel Oil from the at least one receiving vessel.

16. The process of claim 8 wherein Feedstock Heavy Marine Fuel Oil has a sulfur content (ISO 14596 or ISO 8754) greater than 0.5% wt.

17. The process of claim 8 wherein the Product Heavy Marine Fuel Oil leaving the bottom of the at least one reactive distillation vessel complies with ISO 8217:2017 Table 2 and has a sulfur content (ISO 14596 or ISO 8754) between the range of 0.50 mass % to 0.05 mass %.
